(19) United States
(12) Patent Application Publication
(10) Pub. No.: US 2025/0125654 A1
(43) Pub. Date: Apr. 17, 2025

(54) Planetary Energy Collectors

(71) Applicant: Ion Power Group LLC, Navarre, FL (US)

(72) Inventor: Clint McCowen, Navarre, FL (US)

(73) Assignee: Ion Power Group LLC, Navarre, FL (US)

(21) Appl. No.: 18/513,621

(22) Filed: Nov. 19, 2023

Related U.S. Application Data
(63) Continuation-in-part of application No. 18/486,946, filed on Oct. 13, 2023.

(51) Int. Cl. H02J 50/00

(52) U.S. Cl. CPC H02J 50/001; H02J 50/005

(57) ABSTRACT

An energy collection system may collect and use the energy generated by an electric field. Collection electrodes are positioned relative to a planetary body. One or more of the collection electrodes may positioned substantially on, above, or below the planetary body. Example embodiments comprise a power processing module. One or more collection electrodes may comprise a collection device with microscopic points of a cross-section of the collection device exposed to the environment.

### CROSS REFERENCE TO RELATED APPLICATIONS

This application is a continuation-in-part application of U.S. patent application Ser. No. 18/486,946, filed on Oct. 13, 2023, which is incorporated by reference herein.

### TECHNICAL FIELD

The present disclosure is generally related to energy and, more particularly, is related to systems and methods for collecting energy.

### BACKGROUND

The concept of fair weather electricity deals with the electric field and the electric current in the atmosphere propagated by the conductivity of the air. Clear, calm air carries an electrical current, which is the return path for thousands of lightning storms simultaneously occurring at any given moment around the earth. For simplicity, this energy may be referred to as static electricity or static energy. FIG. 1 illustrates a weather circuit for returning the current from lightning, for example, back to ground 10. Weather currents 20, 30 return the cloud to ground current 40.

In a lightning storm, an electrical charge is built up, and electrons arc across a gas, ionizing it and producing the lightning flash. As one of ordinary skill in the art understands, the complete circuit requires a return path for the lightning flash. The atmosphere is the return path for the circuit. The electric field due to the atmospheric return path is relatively weak at any given point because the energy of thousands of electrical storms across the planet are diffused over the atmosphere of the entire Earth during both fair and stormy weather. Other contributing factors to electric current being present in the atmosphere may include cosmic rays penetrating and interacting with the earth's atmosphere, and also the migration of ions, as well as other effects yet to be fully studied.

Some of the ionization in the lower atmosphere is caused by airborne radioactive substances, primarily radon. In most places of the world, ions are formed at a rate of 5-10 pairs per cubic centimeter per second at sea level. With increasing altitude, cosmic radiation causes the ion production rate to increase. In areas with high radon exhalation from the soil (or building materials), the rate may be much higher.

The Sun constantly bombards the Earth with quadrillions of watts of energy (for example, protons, electrons, ions, gamma rays, and beta rays) powering an electric dynamo known as the Global Electric Circuit, producing trillions of atmospheric ions day & night and in all weather. Alpha-active materials are recognized as having a role in contributing to atmospheric ionization. Each alpha particle (for instance, from a decaying radon atom) will, over its range of some centimeters, create approximately 150,000-200,000 ion pairs.

The conductivity of the air due to the drifting of ions increases rapidly with altitude for two reasons. First, the ionization from cosmic rays increases with altitude. Secondly, as the density of air goes down, the mean free path of the ions increases, so that they can travel farther in the electric field before they have a collision, resulting in a rapid increase of conductivity with the increase in altitude. While there is a large amount of usable energy available in the atmosphere, a method or apparatus for efficiently collecting that energy has not been forthcoming. Therefore, a heretofore unaddressed need exists in the industry to address the aforementioned deficiencies and inadequacies.

### SUMMARY

Embodiments of the present disclosure provide systems and methods for collecting energy. Briefly described in architecture, one embodiment of the system, among others, can be implemented by a support structure, the support structure comprising at least one collection device with, in operation, microscopic points of a cross-section of the collection device exposed to the environment from a support structure, the at least one collection device electrically connected to the support structure, the at least one collection device comprising a fluffed portion to increase the number of microscopic points exposed to the environment.

Embodiments of the present disclosure can also be viewed as providing methods for collecting energy. In this regard, one embodiment of such a method, among others, can be broadly summarized by the following steps: suspending at least one collection device with, in operation, microscopic points of a cross-section of the collection device exposed to the environment from a support structure, the at least one collection device electrically connected to the support structure; fluffing a portion of the collection device to increase the number of microscopic points exposed to the environment; and providing a load with an electrical connection to the at least one collection device to draw current.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a circuit diagram of a weather energy circuit.

FIG. 2 is a perspective view of an example embodiment of many energy collectors elevated above ground by a structure.

FIG. 2A is a side view of an energy collection device suspended from a support wire.

FIG. 2B is a side view of an example embodiment of an energy collection device suspended from a support wire and with an additional support member.

FIG. 2C is a perspective view of a support structure for multiple energy collection devices.

FIG. 2D is a side view of an example embodiment of a support structure for multiple energy collection devices.

FIG. 2E is a side view of a support structure for an energy collection device.

FIG. 2F is a side view of an example embodiment of a support structure for an energy collection device.

FIG. 2G is a side view of a support structure for multiple energy collection devices.

FIG. 3 is a circuit diagram of an example embodiment of a circuit for the collection of energy.

FIG. 4 is a circuit diagram of an example embodiment of a circuit for the collection of energy.

FIG. 5 is a circuit diagram of an example embodiment of an energy collection circuit for powering a generator and motor.

FIG. 6 is a circuit diagram of an example embodiment of a circuit for collecting energy and using it for the production of hydrogen and oxygen.

FIG. 7 is a circuit diagram of an example embodiment of a circuit for collecting energy, and using it for driving a fuel cell.

FIG. 8 is a circuit diagram of an example embodiment of a circuit for collecting energy.

FIG. 9 is a flow diagram of an example embodiment of collecting energy with a collection device.

FIG. 10 is a circuit diagram of an example embodiment of a circuit for collecting energy from a dual polarity source.

FIG. 11 is a system diagram of an example embodiment of an energy collection system connected to an automobile vehicle.

FIG. 12 is a system diagram of an example embodiment of an energy collection system connected to a lunar rover vehicle.

FIG. 13 is a system diagram of an example embodiment of an energy collection system comprising collection devices with a diode.

FIG. 14 is a system diagram of an example embodiment of an energy collection system comprising multiple legs of the system of FIG. 13.

FIG. 15 is a system diagram of an example embodiment of a windmill with energy collectors.

FIG. 16 provides a system diagram of an example embodiment of the ion collectors used in electro-hydrodynamic (EH) system of energy collection.

FIG. 17 provides a system diagram of an example embodiment of a system of utilizing encapsulated radioactive or other ionizing radiation sources in collecting energy.

FIG. 18 provides a system diagram of an example embodiment of utilizing unencapsulated radioactive or other ionizing radiation sources in collecting energy.

FIG. 19 provides a system diagram of an example embodiment of utilizing a panel of collection devices for collecting energy.

FIG. 20A provides a perspective view of an example embodiment of an unfrayed energy collector.

FIG. 20B provides a perspective view of an example embodiment of the energy collector of FIG. 20A unfrayed on one end.

FIG. 20C provides a perspective view of an example embodiment of the energy collector of FIG. 20A unfrayed on both ends.

FIG. 20D provides a perspective view of an example embodiment of the energy collector of FIG. 20A unfrayed.

FIG. 21 provides a perspective view of an example embodiment of energy collectors in a wheel and spoke configuration.

FIG. 22 provides a perspective view of an example embodiment of energy collectors in a spherical configuration.

FIG. 23 provides a system diagram of an example embodiment of energy collectors in a mustache configuration.

FIG. 24 provides a system diagram of an example embodiment of energy collectors in a net configuration.

FIG. 25 provides a system diagram of an example embodiment of energy collectors in a surface configuration.

FIG. 26 provides a system diagram of an example embodiment of energy collectors in a surface configuration.

FIG. 27 provides a system diagram of an example embodiment of energy collectors in a surface configuration.

FIG. 28 provides a system diagram of an example embodiment of energy collectors in a surface configuration.

FIG. 29 provides a system diagram of an example embodiment of energy collectors in a surface configuration.

FIG. 30 provides a system diagram of an example embodiment of energy collectors in a surface configuration.

FIG. 31 provides a system diagram of an example embodiment of energy collectors in a surface configuration.

FIG. 32 provides a system diagram of an example embodiment of energy collectors in a surface configuration.

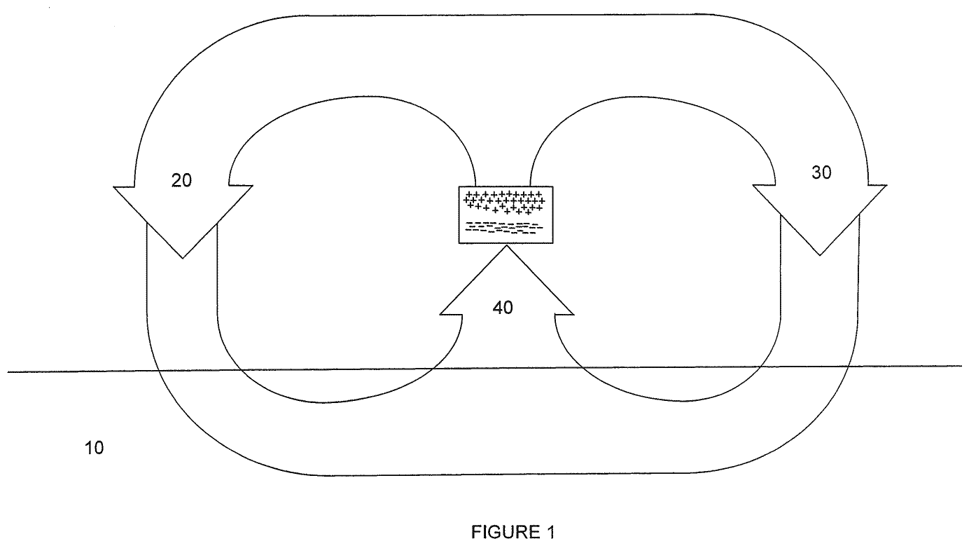

### DETAILED DESCRIPTION

Electric charges on conductors reside entirely on the external surface of the conductors, and tend to concentrate more around sharp points and edges than on flat surfaces. Therefore, an electric field received by a sharp conductive point may be much stronger than a field received by the same charge residing on a large smooth conductive shell. An example embodiment of this disclosure takes advantage of this property, among others, to collect and use the energy generated by an electric field in the atmosphere.

Atmospheric electrical conductivity varies with altitude, storm conditions, and other factors. Near the ground, the voltage is known to increase linearly with height h above the surface, V (h)=χh, which is the condition in which the electric field is constant and there is negligible net charge in the air. Typical clear air values range from 1013 mho/m at ground level to 107 mho/m at 80 km altitude. During a thunderstorm it may be different; but very few studies have been made, so the data are inadequate. To produce the observed current at the observed voltage during storm conditions by simply drawing in surrounding ions, the conductivity would need to be σ=J/E=(I₀/4πrₒ²) (rₒ/Vₒ), which is about 500 times the typical value near the ground.

Theoretical calculations have put the conductivity inside thunderstorms from <0.05 to 0.1 of its clear air value, to as high as 20 times greater than in clear air. A few measurements were made inside thunderstorms finding possibly 10 to 100 times the clear air values. Other measurements in the bases of developing thunderstorms found that the conductivities were always less than clear air value and typically ⅙th to 1/10th the clear air values for the same altitude. Considering these results, it seems unlikely that the conductivity near the ground was high enough to explain the observed current and power. So other factors besides conductivity must be the cause. Therefore, the system is not simply pulling in ions from the surrounding air. If this is all it were doing, then simple metal conductors could be just as effective since they could create the exact same voltage and electric field around them. Therefore, the system does not simply collect ions from the surrounding atmosphere.

The electric field that causes dielectric breakdown of air is about 3 MV/m. As calculated above, the electric field about 10 L from an ion collector will be only about 1.32 kV/m, so it would need to be more than a factor of 2000 times larger to produce ionization over such a large volume. Over smaller volumes, the point charge approximation becomes increasingly inaccurate. Therefore, a thin cylinder approximation achieves a better estimate over those smaller spatial scales. Treating the collector as a cylinder segment of length L and radius r₂ such that the cylinder has the same exterior surface area as an actual (2-sided) ion collector, A=9.69 cm². This yields r₂=0.505 mm. Since r₂<<L, it may be approximated as a line charge so the electric field at a distance z perpendicularly away from the centerline of the line segment is

$$E = \frac{{Q}_{collector}}{2 π {∈}_{0} z \sqrt{{L}^{2} + 4 {z}^{2}}}$$

where Q_{collector}=μ_{L}L is the total charge on one ion collector, and μ_{L} is the equivalent line charge density. The voltage on the ion collector is therefore,

$${V}_{0} = {\int }_{∞}^{{r}_{2}} \vec{E} \cdot d \vec{s} = {\int }_{∞}^{{r}_{2}} \frac{- {Q}_{collector}}{2 π {∈}_{0} z \sqrt{{L}^{2} + 4 {z}^{2}}} dz$$

$${Q}_{collector} = 2 π ∈ {{V}_{0} [ {\int }_{{r}_{2}}^{∞} \frac{dz}{z \sqrt{{L}^{2} + 4 {z}^{2}}} ]}^{- 1} = 374 nC$$

Using this and setting the breakdown limit at E>3 MV/m, z<7.4 mm can be calculated for the region of electrical breakdown (ionization) around the collector. Therefore, any conductor at this voltage with these dimensions will initially ionize that volume of air around it, enabling that volume of air to become a good conductor. Furthermore, once that space is ionized, the current flowing out from it will ionize an even larger volume where the electric field is inadequate to initiate ionization by itself. However, the rate-limiting physics are in the boundary layer where the texture of energy collector material dominates. Therefore, highly textured material produces much higher power than a non-textured material.

Thin strips with these dimensions at this voltage can ionize a volume of air regardless of its material. Certain materials can ionize air when it is in other geometries such as large spheres (the collector material coating the surface of an aerostat) where the radius of curvature would be so large that other materials would not be able to ionize the air. For a sphere, the electric field will be E=V₀/r, so for V₀=40,200 and an ionization limit of E>3 MV, the ionizing region will be r<1.3 cm for any collector, regardless of the material. This is a very small radius and would be the maximum size of an aerostat to create a current at this voltage. Aerostats of only 1.3 cm diameter would not be very practical. However, for example, carbon material has microstructural texture with much smaller radii of curvature r˜0.03 μm at the tips of the protrusions, so ionizing electric fields will occur in the thin boundary layer across the surface of this material even when the collector voltage is as low as

$${V}_{0} ∼ ( 3 MV / m ) ( 0.03 μ m ) ∼ 0.1 V$$

which is remarkably small. Since a sphere of this radius at V₀=40,200 V will ionize air to a distance of 1.3 cm, an ionized boundary layer of greater than 1.3 cm thickness will form all across the surface of the collector, regardless of its macroscopic geometry. Once ionization is initiated, the ionized volume will grow into the surrounding regions where the electric field is smaller, so a much greater volume of ionization results. The effects are the same as before, resulting in a net emission of electrons into the surrounding air and the collection of useful power on the ground.

Ionization around the collector has several possible effects. First, it is assumed that the sky above the collector is positively charged such that the ion collector is negatively charged relative to the surrounding air. In that case, all the positive ions created in the volume around the collector are attracted to the collector where they touch its surface and obtain an electron through the conductivity of the collector through its tether back to ground. This neutralizes the ion back to being a free air molecule, so it diffuses randomly away from the collector's surface. Meanwhile, the electrons that were liberated in the same ionization volume are driven away by the collector's negative electric field. This creates excess negative charge around the ion collector and a negative current density flowing away from the collector. The conductivity in the surrounding space correspondingly increases from the concentration of free electrons, and, since they are being pushed beyond the ionization region, they increase the conductivity over a much larger volume of space.

As the charge density moves away from the collector it spreads out as 1/r², so the conductivity σ(r) decreases correspondingly but the surface area through which this current density flows increases as r2, so the total current is conserved as a function of r. This results in steady state distribution of space charge, electric fields, and current densities in the volume around the ion collector, all vanishing toward infinite distance. Unfortunately, predicting generated power requires knowledge of the current flowing through the system, which can only be obtained experimentally because the rate-limiting physics in the boundary layer is complicated for a number of reasons.

First, ionization happens at some physical rate as a function of the air density, electric field, and concentrations of free ions and electrons. Second, positive ions will crowd toward the collector as a driven-diffusion process limited by molecular kinetics. After being neutralized, they will be released from the surface of the collector and move away in a random diffusion process, resulting in increase in air density and pressure at the surface of the collector. That pressure will tend to push both ions and molecules away from the collector.

Third, the current density in the air produces heat, thereby increasing air pressure, but lowering air density near the collector. The resulting temperature depends not only on generation of heat by this current density but also by conduction of heat away from that region through both the air and the collector, by convection of the air around the collector, by radiation of heat by the gas to the surrounding gas and to the collector, and by advection of the air (external wind) transporting heated air away. Fourth, the rate that ions are neutralized on the surface of the collector depends on molecular kinetics plus the microstructural surface texture of the collector and the complicated electric fields at the length scale of that texture and the conductivity of the collector material. Considering these complexities, it is necessary to measure the effects experimentally.

Benefits of example embodiments of the ion collecting material include, first, the ability to ionize the air even for extremely small atmospheric voltages, enabling large-scale collectors and enabling collection in low voltage conditions (clear air), whereas other materials can only work in small applications (e.g., thin strips) when the atmospheric voltage is lower. The ionization voltage is so low that example embodiments of the ion collectors can always generate power, although the power will still scale with voltage. Second, even when other materials can ionize the air, such as in disturbed weather or when small-scale collectors (such as thin strips) are being used, the collector material should produce much higher current flow and much higher generated power, which can be verified experimentally. This second point is stated as likelihood rather than a known fact because it is not clear what the rate-limiting physics is in the boundary layer of the ion collectors. However, the rate-limiting problems may be addressed by the microstructure of the collector material. The collector material provides vastly more surface area for ions to touch and receive an electron. An example embodiment comprises approximately 70 needles per square micron, with average height of 0.4 micron and radius of 0.03 micron. This material has about 6.3 times as much surface area as a non-textured surface. This analysis suggests that at least one portion of the rate limiting physics is proportional to surface area multiplied by Electric Field. A sphere of radius R₀ in voltage V₀ the power should scale as R₀²×(V₀/R₀)=R₀V₀.

To illustrate the behavior of the system just outside of where the complexities of ionization occur, the simple model is applied far enough away from the collectors to treat them as point charges or small spheres. We use the sphere radius R₀=8.78 mm that provides the same surface area as example embodiments of the ion collectors. This is far enough away that thermal motion of ions dominates over electrically induced motion. The electric flux density through a closed surface equals the enclosed charge, so, by the Leibniz rule, the incremental change in electric field moving radially outward is related to charge density in the atmosphere around the collector:

$${∯}_{atr} \vec{D} \cdot d \vec{A} = 4 π {ϵ}_{0} {r}^{2} E ( r ) = \int {\int }_{0}^{r} ρ ( {r}^{′} ) {dv}^{′} + {Q}_{collector}$$

$$4 {πϵ}_{0} \frac{δ}{δ r} ( {r}^{2} E ( r ) ) = 4 π {r}^{2} ρ ( r )$$

Non-dimensionalizing this equation with x=r/R₀, E=(R₀/V₀)E, and p=(R₀²/ϵ/V₀)ρ, where R₀ is the radius of a collecting sphere, and V₀ is the voltage determined by ground circuitry for that sphere relative to its surrounding atmosphere, and ϵ₀ is the permittivity of free space,

$$\frac{δ}{δ x} ( {x}^{2} ε ( x ) ) = {x}^{2} p ( x )$$

Another relationship between E and ρ is obtained by the current density relationship, where the conductivity σ of the atmosphere is modified by the presence of free charge. In plasma physics, this relationship is used,

$$σ = \frac{{n}_{e} {e}^{2}}{{m}_{e} {v}_{coll}}$$

where nₑ is concentration of free electrons, e is charge of the electron, mₑ is mass of the electron, and v_{coll} is the frequency that electrons collide with air molecules. Here, σ asymptotes to the natural conductivity σ₀ far from the collector, so the following form is used instead (although the additional term may be inconsequential),

$$σ = {σ}_{1} ρ ( r ) + {σ}_{0} = \frac{{n}_{e} {e}^{2}}{{m}_{e} {v}_{coll}} + {σ}_{0}$$

where ρ(r)=nₑe, so σ₁=e/mₑv_{coll}. σ₀ is known empirically from atmospheric physics and varies with storm conditions and altitude as mentioned earlier. The mean free path between collisions of electrons with air molecules is

$${λ}_{free} = 5.6 \frac{{k}_{B} T}{\sqrt{2} π {d}_{a}^{2} P}$$

where dₐ=0.15 nm is collisional cross section diameter of air molecules and 5.6 accounts for small size and large velocity of electrons. Average speed of electrons from purely thermal motions is

$${c}_{avg} = {( 8 \frac{{k}_{B} {T}_{e}}{π {m}_{e}} )}^{\frac{1}{2}}$$

where mₑ is the mass of an electron, k_{B} is Boltzmann's constant, and Tₑ is the electron temperature. Tₑ>>T when electric acceleration adds significant energy to the electrons because the much lower mass of electrons prevents effective energy transfer to the neutral molecules via collision. It may be orders of magnitude higher than T. Tₑ cannot be estimated without complex heat calculations in the region around the conductor, so an estimation is made as Tₑ=10κ T with 0<κ<2, which means κ=1 gives a value of c_{avg} within a factor of 3 of the correct value.

The collision frequency for electrons is,

$${v}_{coll} = \frac{{c}_{avg}}{{λ}_{free}} = \frac{\sqrt{π \frac{{T}_{e}}{T}} {d}_{a}^{2} P}{1.4 \sqrt{{m}_{e} {k}_{B} T}}$$

The time between collisions is t_{coll}=v_coll⁻¹=7×10⁻¹² s. During this time, the electric field accelerates the electron to an additional radial velocity of v_{E}=V_{coll}eE/mₑ=(v₀/r) (t_{coll}e/mₑ). This defines minimum distance rₜₕₑᵣₘ outside of which the velocities are relatively thermalized, v_{E}<c_{avg}. For P≈100,850 Pa (typical clear sky value at h₀=39.6 m), this yields the constraint Tₜₕₑᵣₘ=0.14 m. This is sufficiently small that the approximation may be used to study the region far outside this radius, where σ₁ is decoupled from the electric field and charge density, resulting in much simpler equations. This thermal assumption is not accurate in the region r˜0.14 m. In this thermal approximation,

$${v}_{coll} = \frac{e}{{m}_{e} {v}_{coll}} = 1.4 \frac{e}{{d}_{a}^{2} P} \sqrt{\frac{{k}_{B} {T}_{e}}{π {m}_{e}}}$$

Using the assumption for Te≈10T yields σ₁˜11.1. This gives us the second equation to relate E and ρ:

$$\frac{{I}_{0}}{4 π {r}^{2}} = ( {σ}_{1} ρ ( r ) + {σ}_{0} ) E ( r )$$

where I₀ is determined by the rate-limiting physics in the boundary layer of the collector. Nondimensionalizing this equation with

$$\hat{I} = \frac{{I}_{0}}{4 π {R}_{0} {V}_{0} {σ}_{0}}$$

$$\hat{a} = \frac{{σ}_{0} {R}_{0}^{2}}{{σ}_{1} {ϵ}_{0} {V}_{0}}$$

$$\hat{I} \hat{a} = ( p ( x ) + \hat{a} ) {x}^{2} ε ( x )$$

This system of equations describes behavior of a spherical ion collector power system:

$$\frac{δ}{δ x} ( {x}^{2} ε ( x ) ) = {x}^{2} p ( x )$$

$$\hat{I} \hat{a} = ( p ( x ) + \hat{a} ) {x}^{2} {ε ( x )}^{′} ,$$

$$where$$

$$x > 0.$$

By definition, ε(1)=1. Evaluating the second equation at x=1 (r=R₀) gives

$$p ( 1 ) = \hat{a} ( \hat{I} - 1 )$$

Evaluating the first equation at x=1 gives

$${ε}^{′} ( 1 ) = \hat{a} ( \hat{I} - 1 ) - 2$$

So the slope is positive when

$$\hat{I} > 1 + \frac{2}{\hat{a}}$$

$$\frac{{I}_{0}}{4 π {R}_{0} {V}_{0} {σ}_{0}} > 1 + \frac{2}{\frac{{σ}_{0} {R}_{0}^{2}}{{σ}_{1} {ϵ}_{0} {V}_{0}}}$$

$$\frac{{I}_{0}}{4 π {R}_{0}^{2}} > \frac{{V}_{0} {σ}_{0}}{{R}_{0}} + {σ}_{1} \frac{2 {{ϵ}_{0} ( {V}_{0} )}^{2}}{{R}_{0} {R}_{0}^{2}}$$

$$J ( {R}_{0} ) > ( {σ}_{1} \frac{8 {πϵ}_{0} {V}_{0}}{{R}_{0}^{2}} + {σ}_{0} ) {E}_{{R}_{0}}$$

$$But ,$$

$$J ( {R}_{0} ) = ( {σ}_{1} ρ ( {R}_{0} ) + {σ}_{0} ) {E}_{{R}_{0}}$$

$$So ,$$

$$ρ ( {R}_{0} ) > \frac{8 {πϵ}_{0} {V}_{0}}{{R}_{0}^{2}}$$

If this were the case, the maximum free electron density μₘₐₓ would be at some r>R₀. However, with the numerical values used, this is not the case, so it follows that the maximum free electron density is very close to the surface of the collector and monotonically decreasing. Combining the two equations,

$${x}^{2} ε + \frac{2}{\hat{a}} x {ε}^{2} + \frac{1}{\hat{a}} {x}^{2} {εε}^{′} = \hat{I}$$

In an example embodiment, even 80 meters from the collector, the conductivity is significantly above the background conductivity σ₀=10⁻¹³ mho/m. This enhanced conductivity allows electrons to flow away from the collector completing the power generation circuit, and it is caused by the presence of the free electrons themselves.

It is found empirically that the curves can be made to collapse (at least to excellent approximation in a range of parameters near the nominal case) with the following scaling:

$$y = \frac{x}{{( \hat{a} \hat{I} )}^{1 / 3}} = \frac{r}{{( \hat{a} \hat{I} )}^{1 / 3} {R}_{0}}$$

$$E = \frac{ε}{{( \hat{a} \hat{I} )}^{2 / 3}} = \frac{{R}_{0} E}{{( \hat{a} \hat{I} )}^{2 / 3} {V}_{0}}$$

$$p = \frac{p}{} = \frac{{R}_{0}^{2} ρ}{\hat{a} \hat{I} {ϵ}_{0} {V}_{0}}$$

There is an electron cloud around the collector with characteristic radius y=1, or

$${r}_{cloud} = {( \frac{{I}_{0} {R}_{0}^{4}}{4 {πϵ}_{0} {σ}_{1} {V}_{0}^{2}} )}^{1 / 3}$$

Voltage is in the denominator because the stronger electric field pulls the electrons away from the collector more rapidly. The current/o also scales with voltage. To summarize behavior of this system, free electric charge builds up in the space around the collectors, which modulates the electric field and current density. The electric field, current density, and charge density all decay with distance from the collector. These results provide a physically consistent understanding of how the system functions, providing confidence that the scaling is proportional to surface area and voltage as discussed above.

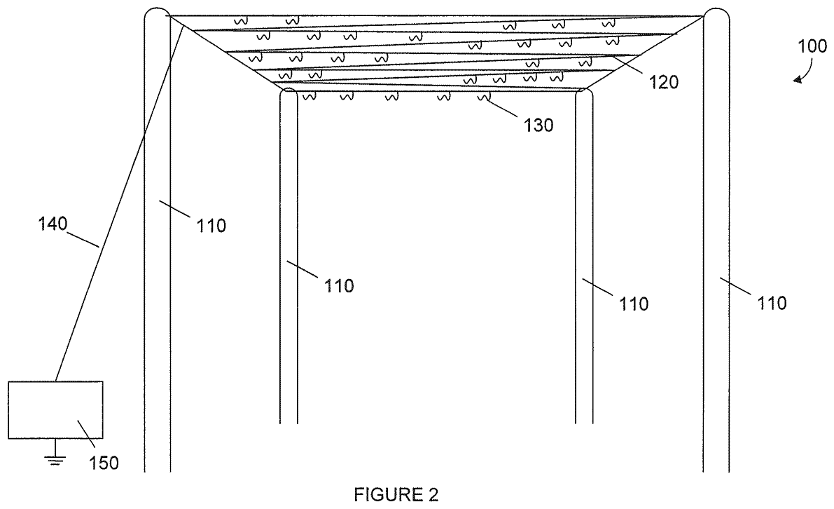

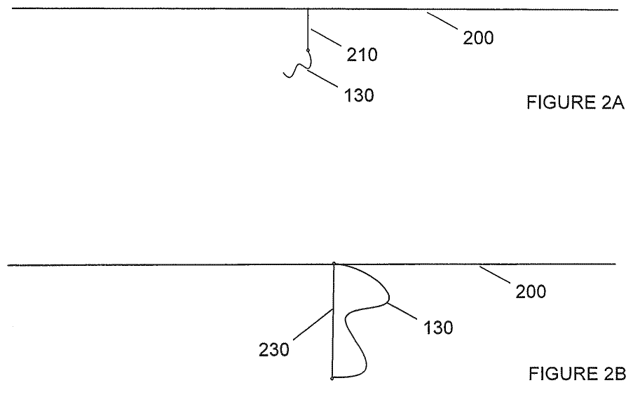

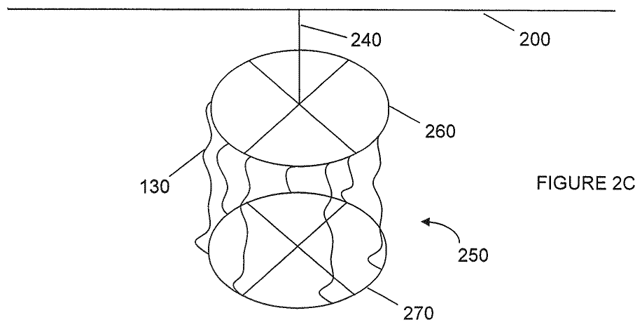

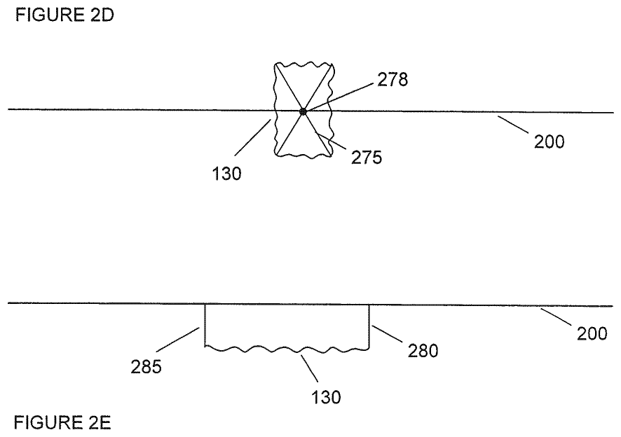

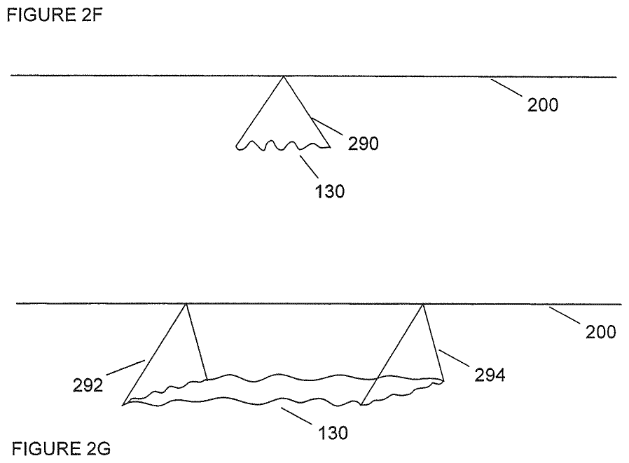

Referring now to collection system 100 presented in FIG. 2, at least one collection device 130 may be suspended from a support wire system 120 supported by poles 110. Collection device 130 may comprise a diode or a collection device individually, or the combination of a diode and a collection device. Support wire system 120 may be electrically connected to load 150 by connecting wire 140. Supporting wire system 120 may be any shape or pattern. Also, conducting wire 140 may be one wire or multiple wires. The collection device 130 in the form of a fiber may comprise any conducting or non-conducting material, including carbon, graphite, Teflon, boron, twisted graphene, carbon-14, and metal. In an example embodiment, the boron collection device may be stabilized by hydrogen. An example embodiment utilizes carbon or graphite fibers for static electricity collection. Support wire system 120 and connecting wire 140 can be made of any conducting material, including aluminum or steel, but most notably, copper. Teflon may be added to said conductor as well, such as non-limiting examples of a Teflon impregnated wire, a wire with a Teflon coating, or Teflon strips hanging from a wire. Conducting wire 120, 140, and 200 may be bare wire, or coated with insulation as a non-limiting example. Wires 120 and 140 are a means of transporting the energy collected by collection device 130.

An example embodiment of the collection fibers as collection device 130 includes graphite or carbon fibers. Graphite and carbon fibers, at a microscopic level, can have hundreds of thousands of points. Atmospheric electricity may be attracted to these points. If atmospheric electricity can follow two paths where one is a flat surface and the other is a pointy, conductive surface, the electrical charge will be attracted to the pointy, conductive surface. Generally, the more points that are present, the higher energy that can be gathered. Therefore, carbon, or graphite fibers are examples that demonstrate collection ability. Other materials that may be used in the collection devices include magic angle graphene, hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, molybdenum sulfide, molybdenene, technetium, ruthenium, rhodium, palladium, silver, cadmium, indium, tin, antimony, tellurium, iodine, xenon, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, bismuth, polonium, astatine, radon, francium, radium, actinium, thorium, protactinium, uranium, neptunium, plutonium. americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, nihonium, flerovium, moscovium, livermorium, tennessine, oganesson, fur, hair, silk, human or animal skin, avian skin or feathers, paper, cotton, wood, amber, hard rubber, glass, quartz, teflon (polytetrafluoroethylene), steel, brass, insect wings, and epidermal skin or surfaces.

In an example embodiment, collection device 130 comprises twistronics of carbon. Through the application of twistronics to carbon or graphite, a 2.5-dimensional mixing of surface and bulk states may be achieved. The manner in which atomic layers of graphite stack on top of one another can result in different types of graphite. These are characterized by different stacking orders of consecutive atomic planes. The majority of naturally appearing graphite has hexagonal stacking, making it one of the most ordinary materials on Earth. The structure of a graphite crystal is a repetitive pattern and this pattern gets disrupted at the surface of the crystal, leading to what's called surface states, which are like waves that slowly fade away with the depth of the crystal.

Van der Waals technology and twistronics are two fields of 2D materials research that may be applied to graphite. Twistronics is the stacking of two 2D crystals at a twist angle to tune the properties of the resulting structure to a great extent, because of the moiré pattern formed at their interface. The moiré pattern can be applied to tune the surface states of graphite. The moiré potential does not just modify the surface states of graphite, but also affects the electronic spectrum of the entire bulk of graphite crystal. In the case of graphite, the moiré potential at an aligned interface penetrates through more than 40 atomic graphitic layers. The unusual 2.5D quantum Hall effect in graphite arises as the interplay between two quantum physics phenomena—Landau quantization in strong magnetic fields and quantum confinement—leading to yet another new type of quantum effect. Other techniques applied to graphene includes stacked, layered, and angled. These techniques as applied to the graphite increase the efficiency that collection device 130 collects energy.

In another example embodiment, collection device 130 comprises a superconductor, such as a non-limiting example of LK-99 material. LK-99 material has been synthesized as a compound of lanarkite [Pb₂SO₅] and copper phosphide [Cu₃P] baked within a 4-day, multi-step, small batch, solid-state synthesis process. LK-99 material can conduct electricity with substantially no resistance—leading to incredible efficiency savings in energy collection by collection device 130. LK-99 also boasts the Meissner effect (originally Meissner-Ochsenfeld), which results in the levitation of materials as they interact with the Meissner-effect-induced magnetic field. LK-99 shows not only superconductivity, but also diamagnetism, responsible for levitation effects. These superconductive materials increase the efficiency that collection device 130 collects energy.

In an example embodiment, collection device 130 comprises galvorn. Galvorn, made from a technique that includes splitting hydrocarbons, is stronger than steel, lighter than aluminum, and has the conductivity of copper. These properties increase the efficiency that collection device 130 collects energy. Galvorn may be produced as tape, yarn, thread, or mesh, among other forms.

In an example embodiment, collection device 130 comprises meta-materials. Meta-materials are composite media that can be engineered to exhibit unique electromagnetic properties. Three concepts-negative-index medium, non-reflecting crystal, and superlens—are foundations of the meta-material theory. Made up from subwavelength building blocks (most often based on metals), these meta-materials allow for extreme control over optical fields. Meta-materials may be made from assemblies of multiple elements fashioned from composite materials such as metals and plastics. These materials may be arranged in repeating patterns, at scales that are smaller than the wavelengths of the phenomena they influence. Meta-materials derive their properties not from the properties of the base materials, but from their newly designed structures. Their precise shape, geometry, size, orientation and arrangement gives them their smart properties capable of manipulating electromagnetic waves: by blocking, absorbing, enhancing, or bending waves, to achieve benefits that go beyond what is possible with conventional materials. Appropriately designed meta-materials can affect waves of electromagnetic radiation or sound in a manner not observed in bulk materials. An electromagnetic meta-material affects electromagnetic waves that impinge on or interact with its structural features, which are smaller than the wavelength. To behave as a homogeneous material accurately described by an effective refractive index, its features must be much smaller than the wavelength.

The unusual properties of meta-materials arise from the resonant response of each constituent element rather that their spatial arrangement into a lattice. It allows considering the local effective material parameters (permittivity and permeability). The resonance effect related to the mutual arrangement of elements is responsible for Bragg scattering, which underlies the physics of photonic crystals, another class of electromagnetic materials. Unlike the local resonances, Bragg scattering and corresponding Bragg stop-band have a low-frequency limit determined by the lattice spacing. The subwavelength approximation ensures that the Bragg stop-bands with the strong spatial dispersion effects are at higher frequencies and can be neglected. The criterion for shifting the local resonance below the lower Bragg stop-band make it possible to build a photonic phase transition diagram in a parameter space, for example, size and permittivity of the constituent element. For microwave radiation, the features are on the order of millimeters. Microwave frequency meta-materials may be constructed as arrays of electrically conductive elements (such as loops of wire) that have suitable inductive and capacitive characteristics. Many microwave meta-materials use split-ring resonators. Plasmonic meta-materials utilize surface plasmons, which are packets of electrical charge that collectively oscillate at the surfaces of metals at optical frequencies. Frequency selective surfaces (FSS) can exhibit subwavelength characteristics and are known variously as artificial magnetic conductors (AMC) or High Impedance Surfaces (HIS). FSS display inductive and capacitive characteristics that are directly related to their subwavelength structure.

Electromagnetic bandgap materials (EBGs) have the goal of creating high quality, low loss, periodic, dielectric structures. An EBG affects photons in the same way semiconductor materials affect electrons. PCs are the perfect bandgap material, because they allow no light propagation. Each unit of the prescribed periodic structure acts like one atom, albeit of a much larger size. EBGs are designed to prevent the propagation of an allocated bandwidth of frequencies, for certain arrival angles and polarizations. Various geometries and structures have been proposed to fabricate EBG's special properties.

EBGs have been manufactured for frequencies ranging from a few gigahertz (GHz) to a few terahertz (THz), radio, microwave and mid-infrared frequency regions. EBG application developments include transmission line, woodpiles made of square dielectric bars and several different types of low gain antennas, for example. Using EBGs in collection device 130 increases the efficiency of energy collection.

Single negative (SNG) meta-materials may have either negative relative permittivity (εᵣ) or negative relative permeability (μᵣ), but not both. They act as meta-materials when combined with a different, complementary SNG, jointly acting as a double negative material (DNG). Epsilon negative media (ENG) display a negative εᵣ while μᵣ is positive. Many plasmas exhibit this characteristic. For example, noble metals such as gold or silver are ENG in the infrared and visible spectrums.

Mu-negative media (MNG) display a positive εᵣ and negative μᵣ. Gyrotropic or gyromagnetic materials exhibit this characteristic. A gyrotropic material is one that has been altered by the presence of a quasistatic magnetic field, enabling a magneto-optic effect. A magneto-optic effect is a phenomenon in which an electromagnetic wave propagates through such a medium. In such a material, left- and right-rotating elliptical polarizations can propagate at different speeds. When light is transmitted through a layer of magneto-optic material, the result is called the Faraday effect: the polarization plane can be rotated, forming a Faraday rotator. The results of such a reflection are known as the magneto-optic Kerr effect (not to be confused with the nonlinear Kerr effect). Two gyrotropic materials with reversed rotation directions of the two principal polarizations are called optical isomers.

Joining a slab of ENG material and slab of MNG material results in properties such as resonances, anomalous tunneling, transparency and zero reflection. Like negative-index materials, SNGs are innately dispersive, so their εᵣ, μᵣ and refraction index n, are a function of frequency.

Hyperbolic meta-materials (HMMs) behave as a metal for certain polarization or direction of light propagation and behave as a dielectric for the other due to the negative and positive permittivity tensor components, giving extreme anisotropy. The material's dispersion relation in wavevector space forms a hyperboloid and therefore it is called a hyperbolic meta-material. The extreme anisotropy of HMMs leads to directional propagation of light within and on the surface. HMMs have showed various potential applications, such as sensing, reflection modulation, imaging, steering of optical signals, and enhanced plasmon resonance effects as non-limiting examples.

Double positive mediums (DPS) do occur in nature, such as naturally occurring dielectrics. Permittivity and magnetic permeability are both positive and wave propagation is in the forward direction. Artificial materials have been fabricated which combine DPS, epsilon negative media (ENG) and mu-negative media (MNG) properties.

Categorizing meta-materials into double or single negative, or double positive, normally assumes that the meta-material has independent electric and magnetic responses described by ε and μ. However, in many cases, the electric field causes magnetic polarization, while the magnetic field induces electrical polarization, known as magnetoelectric coupling. Such media are denoted as bi-isotropic. Media that exhibit magnetoelectric coupling and that are anisotropic (which is the case for many meta-material structures), are referred to as bi-anisotropic.

Four material parameters are intrinsic to magnetoelectric coupling of bi-isotropic media. They are the electric (E) and magnetic (H) field strengths, and electric (D) and magnetic (B) flux densities. These parameters are, u, K, and x or permittivity, permeability, strength of chirality, and the Tellegen parameter, respectively. In this type of media, material parameters do not vary with changes along a rotated coordinate system of measurements. In this sense they are invariant or scalar.

The intrinsic magnetoelectric parameters, κ and χ, affect the phase of the wave. The effect of the chirality parameter is to split the refractive index. In isotropic media, this results in wave propagation only if ε and μ have the same sign. In bi-isotropic media with x assumed to be zero, and κ a non-zero value, different results appear. Either a backward wave or a forward wave can occur. Alternatively, two forward waves or two backward waves can occur, depending on the strength of the chirality parameter.

In the general case, the constitutive relations for bi-anisotropic materials read

$$D = ϵ E + ε H ,$$

$$B = ζ E + μ H$$

where ϵ and μ are the permittivity and the permeability tensors, respectively, whereas ε and ζ are the two magneto-electric tensors. If the medium is reciprocal, permittivity and permeability are symmetric tensors, and

$$ε = - {ζ}^{T} = - i {κ}^{T}$$

where κ is the chiral tensor describing chiral electromagnetic and reciprocal magneto-electric response. The chiral tensor can be expressed as

$$κ = \frac{1}{3} tr ( κ ) I + N + J$$

where tr(κ) is the trace of κ, I is the identity matrix, N is a symmetric trace-free tensor, and J is an antisymmetric tensor. Such decomposition allows for the classification of the reciprocal bianisotropic response and identification of the following three main classes:
(i) chiral media (tr(κ)≠0, N≠0, J=0);
(ii) pseudochiral media (tr(κ)=0, N≠0, J=0); and
(iii) omega media (tr(κ)=0, N=0, J≠0).

Handedness of meta-materials is a potential source of confusion as the meta-material literature includes two conflicting uses of the terms left- and right-handed. The first refers to one of the two circularly polarized waves that are the propagating modes in chiral media. The second relates to the triplet of electric field, magnetic field, and Poynting vector that arise in negative refractive index media, which in most cases are not chiral.

Generally, a chiral and/or bianisotropic electromagnetic response is a consequence of 3D geometrical chirality: 3D-chiral meta-materials are composed by embedding 3D-chiral structures in a host medium and they show chirality-related polarization effects such as optical activity and circular dichroism. The concept of 2D chirality also exists and a planar object is said to be chiral if it cannot be superposed onto its mirror image unless it is lifted from the plane. 2D-chiral meta-materials that are anisotropic and lossy have been observed to exhibit directionally asymmetric transmission (reflection, absorption) of circularly polarized waves due to circular conversion dichromism. On the other hand, bianisotropic response can arise from geometrical achiral structures possessing neither 2D nor 3D intrinsic chirality. Magneto-electric coupling due to extrinsic chirality, where the arrangement of a (achiral) structure together with the radiation wave vector is different from its mirror image, have provided a large, tunable, linear optical activity, nonlinear optical activity, specular optical activity, and circular conversion dichroism.

3D-chiral meta-materials are constructed from chiral materials or resonators in which the effective chirality parameter k is non-zero. Wave propagation properties in such chiral meta-materials demonstrate that negative refraction can be realized in meta-materials with a strong chirality and positive εᵣ and μᵣ. This is because the refractive index n has distinct values for left and right circularly polarized waves, given by

$$η = \pm \sqrt{{ε}_{r} {μ}_{r}} \pm κ$$

It can be seen that a negative index will occur for one polarization if κ>\sqrt{εᵣμᵣ}. In this case, it is not necessary that either or both εᵣ and μᵣ be negative for backward wave propagation.

Frequency selective surface-based meta-materials block signals in one waveband and pass those at another waveband. They have become an alternative to fixed frequency meta-materials. They allow for optional changes of frequencies in a single medium, rather than the restrictive limitations of a fixed frequency response.

The sign of a 3-materials based composite in 3D made out of only positive or negative sign Hall coefficient materials may be inverted. A simple perforation of isotropic material can lead to its change of sign of the Hall coefficient. An anisotropic perforation of a single material can lead to a yet more unusual effect namely the parallel Hall effect. This means that the induced electric field inside a conducting media is no longer orthogonal to the current and the magnetic field but is actually parallel to the magnetic field.

In an example embodiment, collection device 130 comprises plasmonic meta-material. Plasmonic meta-materials exploit surface plasmons, which are produced from the interaction of light with metal-dielectrics. Under specific conditions, the incident light couples with the surface plasmons to create self-sustaining, propagating electromagnetic waves or surface waves known as surface plasmon polaritons. Bulk plasma oscillations make possible the effect of negative mass (density).

In an example embodiment, collection device 130 comprises a meta-material absorber. A meta-material absorber manipulates the loss components of meta-materials' permittivity and magnetic permeability, to absorb large amounts of electromagnetic radiation.

All materials are made of atoms, which are dipoles. These dipoles modify light velocity by a factor n (the refractive index). In a split ring resonator, the ring and wire units act as atomic dipoles: the wire acts as a ferroelectric atom, while the ring acts as an inductor L, while the open section acts as a capacitor C. The ring as a whole acts as an LC circuit. When the electromagnetic field passes through the ring, an induced current is created. The generated field is perpendicular to the light's magnetic field. The magnetic resonance results in a negative permeability; the refraction index is negative as well.

There are several (mathematical) material models of the frequency response in DNGs. One of these is the Lorentz model, which describes electron motion in terms of a driven-damped, harmonic oscillator. The Debye relaxation model applies when the acceleration component of the Lorentz mathematical model is small compared to the other components of the equation. The Drude model applies when the restoring force component is negligible and the coupling coefficient is generally the plasma frequency.

Three-dimensional composites of metal/non-metallic inclusions periodically/randomly embedded in a low permittivity matrix are usually modeled by analytical methods, including mixing formulas and scattering-matrix based methods. The particle is modeled by either an electric dipole parallel to the electric field or a pair of crossed electric and magnetic dipoles parallel to the electric and magnetic fields, respectively, of the applied wave. These dipoles are the leading terms in the multipole series. They are the only existing ones for a homogeneous sphere, whose polarizability can be easily obtained from the Mie scattering coefficients. In general, this procedure is known as the “point-dipole approximation”, which is a good approximation for meta-materials consisting of composites of electrically small spheres. Merits of these methods include low calculation cost and mathematical simplicity.

In an example embodiment, collection device 130 comprises covalent organic frameworks (COFs). COFs are a class of materials that form two- or three-dimensional structures through reactions between organic precursors resulting in strong, covalent bonds to afford porous, stable, and crystalline materials. In COFs, organic materials such as organic polymers involve the construction of porous, crystalline materials with rigid structures that granted exceptional material stability in a wide range of solvents and conditions. Through the development of reticular chemistry, precise synthetic control is achieved, resulting in ordered, nano-porous structures with highly preferential structural orientation and properties which are synergistically enhanced and amplified. COF secondary building units (SBUs), or precursors may be selected and the final structure could be predetermined, modified with exceptional control to enable fine-tuning of emergent properties. This level of control facilitates the COF material to be designed and synthesized for the collection of ions.

Porous crystalline solids consist of secondary building units (SBUs) which assemble to form a periodic and porous framework. An almost infinite number of frameworks can be formed through various SBU combinations leading to unique material properties for specific applications. Types of porous crystalline solids include zeolites, metal-organic frameworks (MOFs), and covalent organic frameworks (COFs). Zeolites are microporous, aluminosilicate minerals commonly used as commercial adsorbents. MOFs are a class of porous polymeric material, consisting of metal ions linked together by organic bridging ligands and are a new development on the interface between molecular coordination chemistry and materials science. COFs are another class of porous polymeric materials, consisting of porous, crystalline, covalent bonds that usually have rigid structures, exceptional thermal stabilities (to temperatures up to 600° C.), are stable in water and low densities. They exhibit permanent porosity with specific surface areas surpassing those of well-known zeolites and porous silicates.

Integration of SBUs into a covalent framework results in the synergistic emergence of conductivities much greater than the monomeric values. The nature of the SBUs can improve conductivity. Through the use of highly conjugated linkers throughout the COF scaffold, the material can be engineered to be fully conjugated, enabling high charge carrier density as well as through- and in-plane charge transport. For instance, COF material (NiPc-Pyr COF) from nickel phthalocyanine (NiPc) and pyrene organic linkers has a conductivity of 2.51×10⁻³ S/m, which is several orders of magnitude larger than the undoped molecular NiPc, at 10⁻¹¹ S/m. A similar COF structure, CoPc-Pyr COF, exhibits a conductivity of 3.69×10⁻³ 10−3 S/m. In both previously mentioned COFs, the 2D lattice allows for full π-conjugation in the x and y directions as well as π-conduction along the z axis due to the fully conjugated, aromatic scaffold and π-π stacking, respectively. Emergent electrical conductivity in COF structures is especially important for ion harvesting applications.

In an example embodiment, collection device 130 comprises angled or twisted materials, such as twisted graphite which may include stacking 2D sheets together at a small twist angle. In an example embodiment, a single layer of graphene is placed on top of a thin, bulk graphite crystal, and then a twist angle of around 1 degree is introduced between graphite and graphene. Novel and unexpected electrical properties are not just at the twisted interface, but deep in the bulk graphite as well. The twist angle is critical to generating these properties. A twist angle between 2D sheets, like two sheets of graphene, creates what's called a moiré pattern, which alters the flow of charged particles like electrons and induces exotic properties in the material.

In an example embodiment, a single sheet of graphene atop the bulk crystal is twisted resulting in the electrical properties of the whole material differing markedly from typical graphite. Additionally, when a magnetic field is introduced, electrons deep in the graphite crystal adopt unusual properties similar to those of electrons at the twisted interface. Essentially, the single twisted graphene-graphite interface becomes inextricably mixed with the rest of the bulk graphite. For 2D sheets, moiré patterns generate properties that are useful for ion harvesting.

The approach of generating a twist angle between graphene and a bulk graphite crystal could also be used to create 2D-3D hybrids of its sister materials, including tungsten ditelluride and zirconium pentatelluride. This could unlock a new approach to re-engineering the properties of conventional bulk materials using a single 2D interface.

In an example embodiment, collection device 130 comprises MXene. MXenes are a class of two-dimensional inorganic compounds, that consist of atomically thin layers of transition metal carbides, nitrides, or carbonitrides. MXenes accept a variety of hydrophilic terminations. As-synthesized MXenes prepared via HF etching have an accordion-like morphology, which can be referred to as multi-layer MXene (ML-MXene), or few-layer MXene (FL-MXene) given fewer than five layers. Because the surfaces of MXenes can be terminated by functional groups, the naming convention Mₙ₊₁XₙTₓ can be used, where T is a functional group (e.g. O, F, OH, Cl).

With a high electron density at the Fermi level, MXene monolayers are metallic. In MAX phases, N(E_{F}) is mostly M 3d orbitals, and the valence states below E_{F} are composed of two sub-bands. One, sub-band A, made of hybridized Ti 3d-Al 3p orbitals, is near E_{F}, and another, sub-band B, −10 to −3 eV below E_{F} which is due to hybridized Ti 3d-C 2p and Ti 3d-Al 3s orbitals. Said differently, sub-band A is the source of Ti—Al bonds, while sub-band B is the source of Ti—C bond. Removing A layers causes the Ti 3d states to be redistributed from missing Ti-AI bonds to delocalized Ti—Ti metallic bond states near the Fermi energy in Ti₂, therefore N(E_{F}) is 2.5-4.5 times higher for MXenes than MAX phases. The energy positions of the O 2p (˜6 eV) and the F 2p (˜9 eV) bands from the Fermi level of Ti₂CTₓ and Ti₃C₂Tₓ both depend on the adsorption sites and the bond lengths to the termination species. Significant changes in the Ti—O/F coordination are observed with increasing temperature in the heat treatment. Only MXenes without surface terminations are magnetic. Cr₂C, Cr₂N, and Ta₃C₂ are ferromagnetic; Ti₂C₂ and Ti₃N₂ are anti-ferromagnetic.

In an example embodiment, collection device 130 comprises at least one of fullerene and graphullerene. A fullerene is an allotrope of carbon whose molecule consists of carbon atoms connected by single and double bonds so as to form a closed or partially closed mesh, with fused rings of five to seven atoms. The molecule may be a hollow sphere, ellipsoid, tube, or many other shapes and sizes. Fullerenes with a closed mesh topology are informally denoted by their empirical formula Cn, often written Cn, where n is the number of carbon atoms. However, for some values of n there may be more than one isomer. The family is named after buckminsterfullerene (C60), the most famous member, which in turn is named after Buckminster Fuller. The closed fullerenes, especially C60, are also informally called buckyballs for their resemblance to the standard ball of association football (“soccer”). Nested closed fullerenes have been named bucky onions. Cylindrical fullerenes are also called carbon nanotubes or buckytubes. The bulk solid form of pure or mixed fullerenes is called fullerite.

The discovery of fullerenes greatly expanded the number of known allotropes of carbon, which had previously been limited to graphite, diamond, and amorphous carbon such as soot and charcoal. They have been the subject of intense research, both for their chemistry and for their technological applications, especially in materials science, electronics, and nanotechnology. Carbon nanotubes are cylindrical fullerenes. These tubes of carbon are usually only a few nanometers wide, but they can range from less than a micrometer to several millimeters in length. They often have closed ends, but can be open-ended as well. There are also cases in which the tube reduces in diameter before closing off. Their unique molecular structure results in extraordinary macroscopic properties, including high tensile strength, high electrical conductivity, high ductility, high heat conductivity, and relative chemical inactivity (as it is cylindrical and “planar”—that is, it has no “exposed” atoms that can be easily displaced).

Graphullerene, a modular form of carbon, is made up of layers of fullerenes with graphullerite crystals. Graphullerenes incorporated into new kinds of optical and electronic devices can withstand much higher currents and temperatures with the material an effective dissipator of heat. This thermal conductivity property is important in collecting energy from the atmosphere. Graphullerene may be a complementary use to fullerene in many future solar, wind, battery, and sensor products.

In at least one example embodiment, the height of support wire 120 may be an important factor. The higher that collection device 130 is from ground, the larger the voltage potential between collection device 130 and electrical ground. The electric field may be more than 100 volts per meter under some conditions. When support wire 120 is suspended in the air at a particular altitude, wire 120 will itself collect a very small charge from ambient voltage. When collection device 130 is connected to support wire 120, collection device 130 becomes energized and transfers the energy to support wire 120.

A diode, not shown in FIG. 2, may be connected in several positions in collection system 100. A diode is a component that restricts the direction of movement of charge carriers. It allows an electric current to flow in one direction, but essentially blocks it in the opposite direction. A diode can be thought of as the electrical version of a check valve. The diode may be used to prevent the collected energy from discharging into the atmosphere through the collection fiber embodiment of collection device 130. An example embodiment of the collection device comprises the diode with no collection fiber. A preferred embodiment, however, includes a diode at the connection point of a collection fiber to support system 120 such that the diode is elevated above ground. Multiple diodes may be used between collection device 130 and load 150. Additionally, in an embodiment with multiple fibers, the diodes restrict energy that may be collected through one fiber from escaping through another fiber.

Collection device 130 may be connected and arranged in relation to support wire system 120 by many means. Some non-limiting examples are provided in FIGS. 2A-2G using a collection fiber embodiment. FIG. 2A presents support wire 200 with connecting member 210 for collection device 130. Connection member 210 may be any conducting material allowing for the flow of electricity from connection device 130 to support wire 200. Then, as shown in FIG. 2, the support wire 200 of support system 120 may be electrically connected through conducting wire 140 to load 150. A plurality of diodes may be placed at any position on the support structure wire. A preferred embodiment places a diode at an elevated position at the connection point between a collection fiber embodiment of collection device 130 and connection member 210.

Likewise, FIG. 2B shows collection device 130 electrically connected to support wire 200 and also connected to support member 230. Support member 230 may be connected to collection device 130 on either side. Support member 230 holds the collection device 130 steady on both ends instead of letting it move freely. Support member 230 may be conducting or non-conducting. A plurality of diodes may be placed at any position on the support structure wire. A preferred embodiment places a diode at elevated position at the connection point between collection device 130 and support wire 200 or between collection device 130, support member 230, and support wire 200.

FIG. 2C presents multiple collection devices in a squirrel cage arrangement with top and bottom support members. Support structure 250 may be connected to support structure wire 200 by support member 240. Structure 250 has a top 260 and a bottom 270 and each of the multiple collection devices 130 are connected on one end to top 260 and on the other end to bottom 270. A plurality of diodes may be placed at any position on support structure 250. A preferred embodiment places a diode at an elevated position at the connection point between collection device 130 and support structure wire 200.

FIG. 2D presents another example embodiment of a support structure with support members 275 in an x-shape connected to support structure wire 200 at intersection 278 with collection devices 130 connected between ends of support members 275. A plurality of diodes may be placed at any position on the support structure. A preferred embodiment places a diode at an elevated position at the connection point between collection devices 130 and support wire 200.

FIG. 2E provides another example embodiment for supporting collection devices 130. Collection devices 130 may be connected on one side to support member 285, which may be connected to support structure wire 200 in a first location and on the other side to support member 280, which may be connected to support structure wire 200 in a second location on support structure wire 200. The first and second locations may be the same location, or they may be different locations, even on different support wires. A plurality of diodes may be placed at any position on the support structure. A preferred embodiment places one or more diodes at elevated positions at the connection point(s) between collection devices 130 and support wire 200.

FIG. 2F presents another example embodiment of a support for a collection device. Two support members 290 may support either side of a collection device and are connected to support wire 200 in a single point. A plurality of diodes may be placed at any position on the support structure. A preferred embodiment places a diode at an elevated position at the connection point between collection device 130 and support wire 200.

FIG. 2G provides two supports as provided in FIG. 2F such that at least two support members 292, 294 may be connected to support structure wire 200 in multiple locations and collection devices 130 may be connected between each end of the support structures. Collection devices 130 may be connected between each end of a single support structure and between multiple support structures. A plurality of diodes may be placed at any position on the support structure. A preferred embodiment places one or more diodes at elevated positions at the connection point(s) between collection device 130 and support structure wire 200.

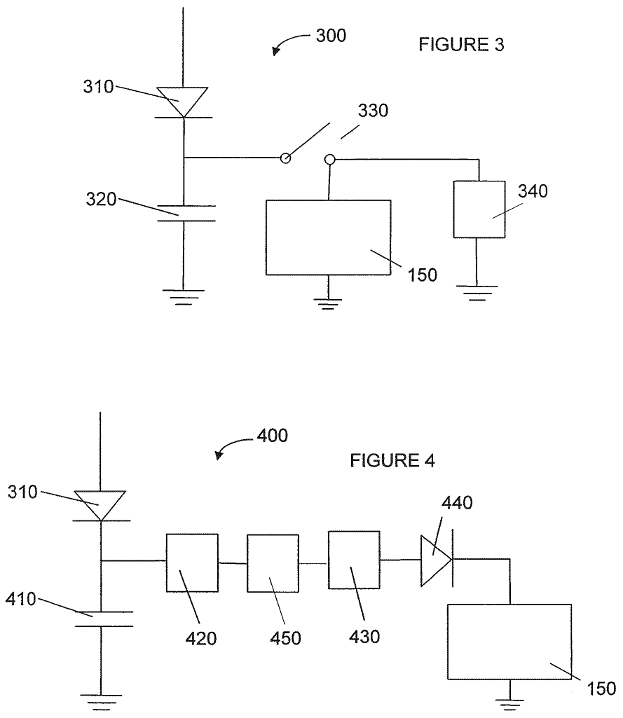

FIG. 3 provides a schematic diagram of storing circuit 300 for storing energy collected by one or more collection devices (130 from FIG. 2). Load 150 induces current flow. Diode 310 may be electrically connected in series between one or more collection devices (130 from FIG. 2) and load 150. A plurality of diodes may be placed at any position in the circuit. Switch 330 may be electrically connected between load 150 and at least one collection device (130 from FIG. 2) to connect and disconnect the load. Capacitor 320 may be connected in parallel to the switch 330 and load 150 to store energy when switch 330 is open for delivery to load 150 when switch 330 is closed. Rectifier 340 may be electrically connected in parallel to load 150, between the receiving end of switch 330 and ground. Rectifier 340 may be a full-wave or a half-wave rectifier. Rectifier 340 may include a diode electrically connected in parallel to load 150, between the receiving end of switch 330 and ground. The direction of the diode of rectifier 340 is optional.

In an example embodiment provided in FIG. 4, storage circuit 400 stores energy from one or more collection devices (130 from FIG. 2) by charging capacitor 410. If charging capacitor 410 is not used, then the connection to ground shown at capacitor 410 is eliminated. A plurality of diodes may be placed at any position in the circuit. Diode 310 may be electrically connected in series between one or more collection devices (130 from FIG. 2) and load 150. Diode 440 may be placed in series with load 150. The voltage from capacitor 410 can be used to charge spark gap 420 when it reaches sufficient voltage. Spark gap 420 may comprise one or more spark gaps in parallel. Non-limiting examples of spark gap 420 include mercury-reed switches and mercury-wetted reed switches. When spark gap 420 arcs, energy will arc from one end of the spark gap 420 to the receiving end of the spark gap 420. The output of spark gap 420 may be electrically connected in series to rectifier 450. Rectifier 450 may be a full-wave or a half-wave rectifier. Rectifier 450 may include a diode electrically connected in parallel to transformer 430 and load 150, between the receiving end of spark gap 420 and ground. The direction of the diode of rectifier 450 is optional. The output of rectifier 450 is connected to transformer 430 to drive load 150. Although diodes and switches (such as spark-gap 420) may be used in collecting energy, configurations without diode or switch may be implemented to directly charge capacitors, batteries, or connect to a utility system/power grid.

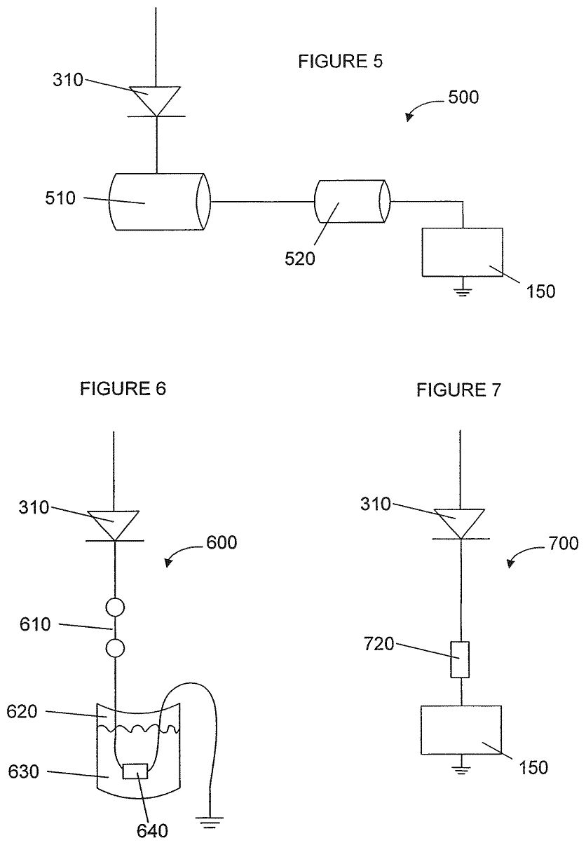

FIG. 5 presents motor driver circuit 500. One or more collection devices (130 from FIG. 2) are electrically connected to static electricity motor 510, which powers generator 520 to drive load 150. A plurality of diodes may be placed at any position in the circuit. Motor 510 may also be directly connected to load 150 to drive it directly.

FIG. 6 demonstrates a circuit 600 for producing hydrogen. A plurality of diodes may be placed at any position in the circuit. One or more collection devices (130 from FIG. 2) are electrically connected to primary spark gap 610, which may be connected to secondary spark gap 640. Non-limiting examples of spark gaps 610, 640 include mercury-reed switches and mercury-wetted reed switches. Secondary spark gap 640 may be immersed in water 630 within container 620. When secondary spark gap 640 immersed in water 630 is energized, spark gap 640 may produce bubbles of hydrogen and oxygen, which may be collected to be used as fuel.

FIG. 7 presents circuit 700 for driving a fuel cell. A plurality of diodes may be placed at any position in the circuit. Collection devices (130 from FIG. 2) provide energy to fuel cell 720 which drives load 150. Fuel cell 720 may produce hydrogen and oxygen.

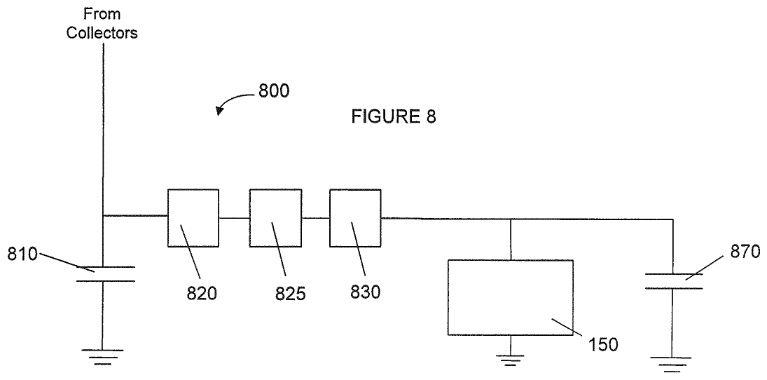

FIG. 8 presents example circuit 800 for the collection of energy. Storage circuit 800 stores energy from one or more collection devices (130 from FIG. 2) by charging capacitor 810. If charging capacitor 810 is not used, then the connection to ground shown at capacitor 810 is eliminated. A plurality of diodes may be placed at any position in the circuit. The voltage from capacitor 810 can be used to charge spark gap 820 when it reaches sufficient voltage. Spark gap 820 may comprise one or more spark gaps in parallel or in series. Non-limiting examples of spark gap 820 include mercury-reed switches and mercury-wetted reed switches. When spark gap 820 arcs, energy will arc from one end of spark gap 820 to the receiving end of spark gap 820. The output of spark gap 820 may be electrically connected in series to rectifier 825. Rectifier 825 may be a full-wave or a half-wave rectifier. Rectifier 825 may include a diode electrically connected in parallel to inductor 830 and load 150, between the receiving end of spark gap 820 and ground. The direction of the diode of rectifier 825 is optional. The output of rectifier 825 is connected to inductor 830. Inductor 830 may be a fixed value inductor or a variable inductor. Capacitor 870 may be placed in parallel with load 150.

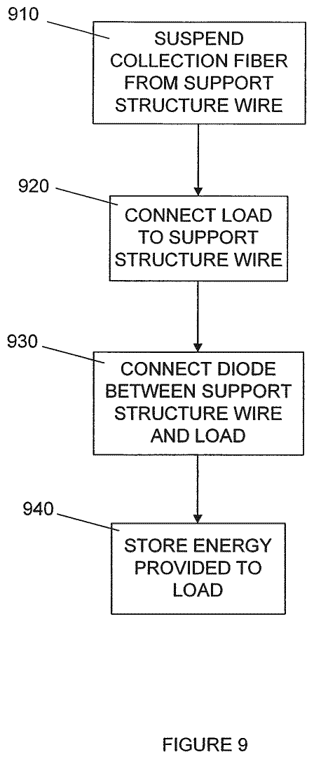

FIG. 9 presents a flow diagram of a method for collecting energy. In block 910, one or more collection devices may be suspended from a support structure wire. In block 920, a load may be electrically connected to the support structure wire to draw current. In block 930 a diode may be electrically connected between the support structure wire and the electrical connection to the load. In block 940, energy provided to the load may be stored or otherwise utilized.

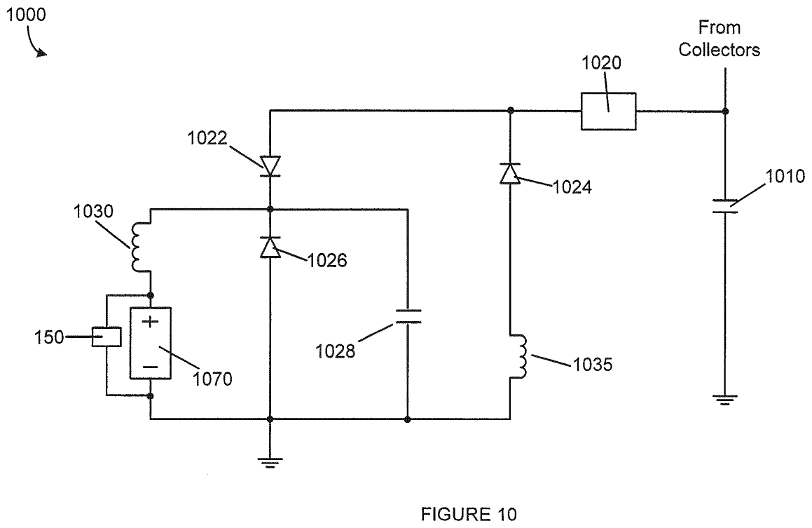

FIG. 10 presents circuit 1000 as an example embodiment for the collection of energy from a dual polarity source. This may be used, for example, to collect atmospheric energy that reverses in polarity compared with the ground. Such polarity reversal has been discovered as occurring occasionally on Earth during, for example, thunderstorms and bad weather, but has also been observed during good weather. Such polarity reversal may occur on other planetary bodies, including Mars and Venus, as well. Energy polarity on other planets, in deep space, or on other heavenly bodies, may be predominantly negative or predominantly positive. Collector devices (130 from FIG. 2), which may comprise graphene, silicene, and/or other like materials, are capable of collecting positive energy and/or negative energy, and circuit 1000 is capable of processing positive and/or negative energy, providing an output which is always positive. Circuit 1000 may collect energy from one or more collection devices (130 from FIG. 2). Charging capacitor 1010 may be used to store a charge until the voltage at spark gap 1020 achieves the spark voltage. Capacitor 1010 is optional.

A plurality of diodes may be placed in a plurality of positions in circuit 1000. The voltage from capacitor 1010 may be used to charge spark gap 1020 to a sufficient voltage. Spark gap 1020 may comprise one or more spark gaps in parallel or in series. Non-limiting examples of spark gap 1020 include mercury-reed switches, mercury-wetted reed switches, open-gap spark gaps, and electronic switches. When spark gap 1020 arcs, energy will arc from an emitting end of spark gap 1020 to a receiving end of spark gap 1020. The output of spark gap 1020 is electrically connected to the anode of diode 1022 and the cathode of diode 1024. The cathode of diode 1022 is electrically connected to the cathode of diode 1026 and inductor 1030. Inductor 1030 may be a fixed value inductor or a variable inductor. The anode of diode 1026 is electrically connected to ground. Capacitor 1028 is electrically connected between ground and the junction of the cathodes of diode 1022 and diode 1026. Inductor 1035 is electrically connected between ground and the anode of diode 1024. Inductor 1035 may be a fixed value inductor or a variable inductor. Capacitor 1070, the anode of diode 1026, inductor 1035, and load 1050 are electrically connected to ground. Capacitor 1070 may be placed in parallel with load 150.

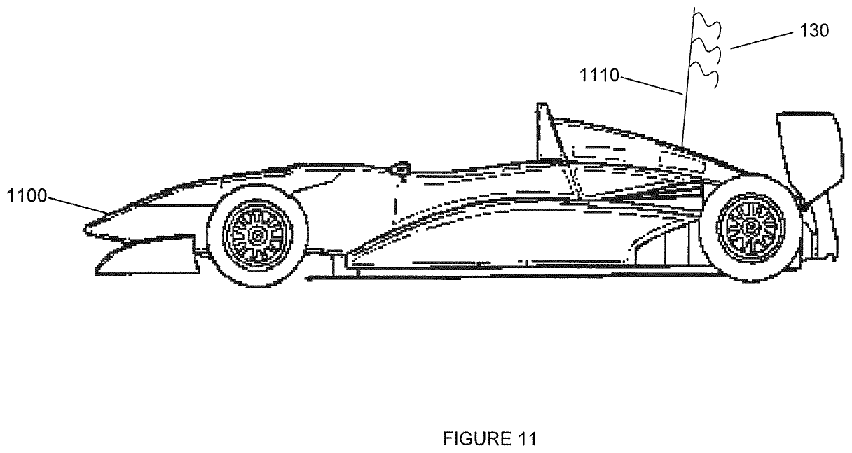

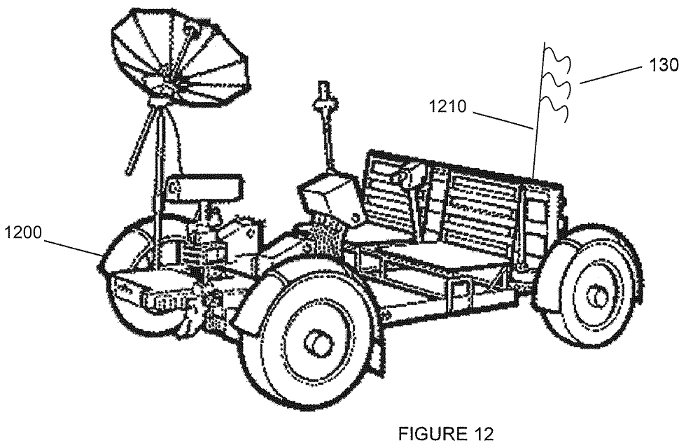

FIGS. 11 and 12 provide example embodiments of vehicle 1110, which utilizes electricity, the vehicle employing systems of energy collection provided herein. Vehicle 1100 in FIG. 11 is shown as an automobile vehicle, but could be any means of locomotion that utilizes electricity, including a car, a train, a motorcycle, a boat, an airplane, robotic rovers, space craft, etc. Vehicle 1200 in FIG. 12 is shown as a lunar rover vehicle. In FIGS. 11 and 12, support rod 1110, 1210 is electrically connected to an electrical system in vehicle 1100, 1200. Energy collectors 130, which may comprise graphene, silicene, and/or other like materials, are electrically connected to support rod 1110, 1210 and may be used to supply energy to electrical circuits within the vehicle. A non-limiting use includes a top-off charge for a battery system, on-board hydrogen production, and/or assisting in the same. Energy collectors 130 may be used to augment the efficiency of the locomotion that utilizes electrical energy as well.

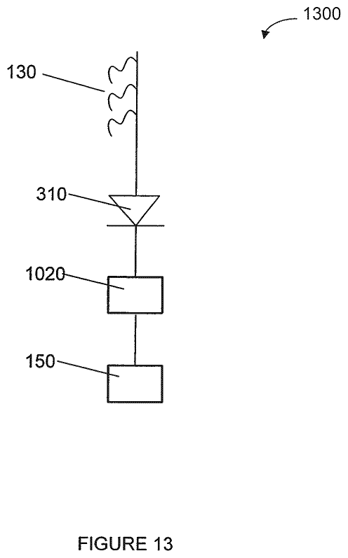

FIG. 13 provides an example embodiment of energy collection system 1200 in which diode 310 is used to isolate collection devices 130 from spark gap 1020 and load 150. Collection devices 130 may comprise graphite, carbon fibers, carbon/carbon fibers, graphene, silicene, and/or other like materials, or a mixture thereof.

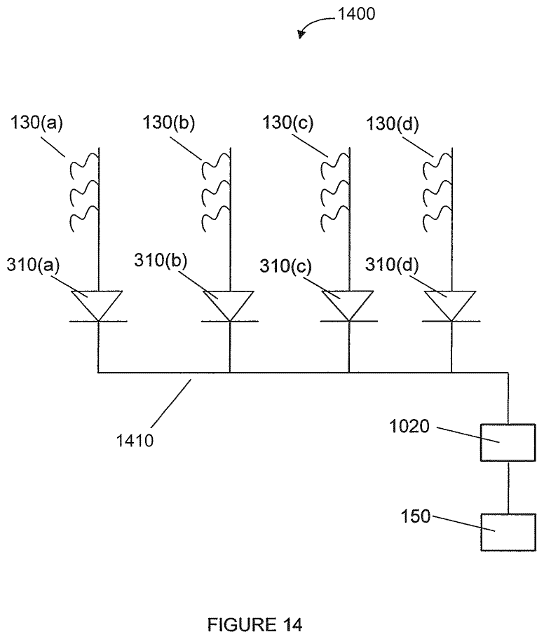

FIG. 14 provides an example embodiment of energy collection system 1400 in which a plurality of energy collection systems, such as that provided in FIG. 13, are combined. Each leg consisting of collection devices 130, which may comprise graphene, silicene, and/or other like materials, and diode 310 are connected in parallel with other legs, each leg electrically connected to trunk wire 1410. The legs could also be connected serially. Trunk wire 1410 is electrically connected to a collection circuit, which may comprise load 150 and spark gap 1020 in any configuration that has been previously discussed. Each leg may comprise one or more collection devices 130 and at least one diode electrically connected between the collection devices and the collection circuit. Although three collection devices 130 are shown on each leg, any number of collection devices may be used. Although four legs are shown, any number of legs may be used.

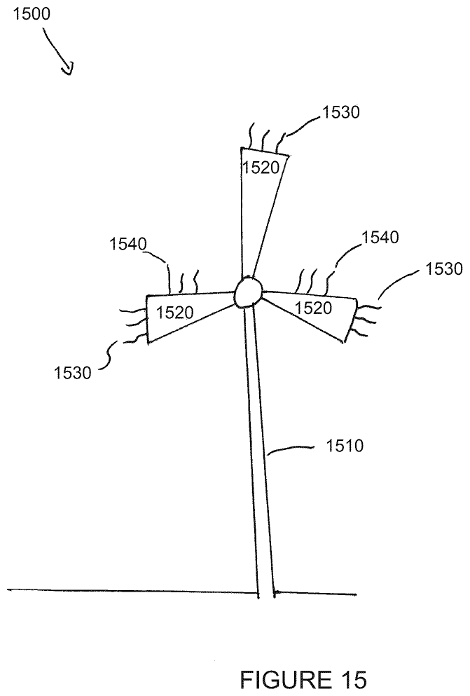

FIG. 15 presents a system diagram of an example embodiment of a windmill with energy collectors, which may comprise graphene, silicene, and/or other like materials in an example embodiment. A windmill is an engine powered by the energy of wind to produce alternative forms of energy. They may, for example, be implemented as small tower mounted wind engines used to pump water on farms. The modern wind power machines used for generating electricity are more properly called wind turbines. Common applications of windmills are grain milling, water pumping, threshing, and saw mills. Over the ages, windmills have evolved into more sophisticated and efficient wind-powered water pumps and electric power generators. In an example embodiment, as provided in FIG. 10, windmill tower 1500 of suitable height and/or propeller 1520 of windmill tower 1500 may be equipped with energy collecting devices 1530, 1540, which may comprise graphene, silicene, and/or other like materials in an example embodiment. Collecting devices 1530, 1540 may turn windmill 1500 into a power producing asset even when there is not enough wind to turn propellers 1520. During periods when there is enough wind to turn propellers 1520, collecting devices 1530, 1540 may supplement/boost the amount of energy the windmill produces.

A windmill is an engine powered by the energy of wind to produce alternative forms of energy. They may, for example, be implemented as small tower mounted wind engines used to pump water on farms. The modern wind power machines used for generating electricity are more properly called wind turbines. Common applications of windmills are grain milling, water pumping, threshing, and saw mills. Over the ages, windmills have evolved into more sophisticated and efficient wind-powered water pumps and electric power generators. In an example embodiment, as provided in FIG. 15, windmill tower 1500 of suitable height and/or propeller 1520 of windmill tower 1500 may be equipped with energy collecting devices 1530, 1540. Collection devices 1530, 1540 may turn windmill 1500 into a power producing asset even when there is not enough wind to turn propellers 1520. During periods when there is enough wind to turn propellers 1520, collection devices 1530, 1540 may supplement/boost the amount of energy the windmill produces.

Windmill 1500, properly equipped with ion collectors 1530, 1540, such as a non-limiting example of fibers with graphene, silicene, and/or other like materials, can produce electricity: 1) by virtue of providing altitude to the collectors to harvest ions, and 2) while the propeller is turning, by virtue of wind blowing over the collector producing electricity, among other reasons, via the triboelectric effect (however, it is also possible for the triboelectric effect to occur, producing electricity, in winds too weak to turn the propeller).

There are at least two ways that energy collection devices may be employed on or in a windmill propeller to harvest energy. Propellers 1520 may be equipped with energy collectors 1530, 1540 attached to, or supported by, propeller 1520 with wires (or metal embedded in, or on propeller 1520) electrically connecting energy collectors 1530, 1540, which may comprise graphene, silicene, and/or other like materials, to a load or power conversion circuit. There may be a requirement to electrically isolate energy collectors 1530, 1540, which are added to propeller 1520, from electrical ground, so that the energy collected does not short to ground through propeller 1520 itself or through support tower 1510, but rather is conveyed to the load or power conversion circuit. Energy collectors may be connected to the end of propellers 1520 such as collectors 1530. Alternatively, energy collectors may be connected to the sides of propellers 1520 such as collectors 1540.

Alternatively, propeller 1520 may be constructed of carbon fiber or other suitable material, with wires (or the structural metal supporting propeller 1520 may be used) electrically connecting to a load or power conversion circuit. In the case of propeller 1520 itself being constructed of carbon fiber, for example, the fiber may be ‘rough finished’ in selected areas so that the fiber is “fuzzy.” For example, small portions of it may protrude into the air as a means of enhancing collection efficiency. The fuzzy parts of collectors 1530, 1540 may do much of the collecting. There may be a requirement to electrically isolate carbon fiber propeller 1520 from electrical ground, so that the energy it collects does not short to ground through metal support tower 1510, but rather is conveyed to the load or power conversion circuit. Diodes may be implemented within the circuit to prevent the backflow of energy, although diodes may not be necessary in some applications.

In an alternative embodiment, windmill 1500 may be used as a base on which to secure an even higher extension tower to support the energy collectors and/or horizontal supports extending out from tower 1510 to support the energy collectors. Electrical energy may be generated via ion collection due to altitude and also when a breeze or wind blows over the collectors supported by tower 1510.

In alternative embodiments to windmill 1500, other non-limiting example support structures include airplanes, drones, aerostats, blimps, balloons, kites, satellites, cars, boats, trucks, (including automobile and other transportation conveyance tires), trains, motorcycles, bikes, skateboards, scooters, hovercraft (automobiles and conveyance of any kind), billboards, cell towers, radio towers, camera towers, flag poles, towers of any kind including telescopic, light poles, utility poles, water towers, buildings, sky scrapers, coliseums, roof tops, solar panel and all fixed or mobile structures exceeding 1 inch in height above ground or sea level.

An example embodiment of a support structure may also include cell phones and other electronic devices and their cases, including cases containing rechargeable batteries. For example, someone may set her cell phone or other electronic device or battery pack on the window ledge of a tall apartment building to help charge it. Other example support structures may include space stations, moon and Mars structures, rockets, planetary rovers and drones including robots and artificial intelligence entities.

Under some conditions, ambient voltage may be found to be 180-400 volts at around 6 ft, with low current. With the new generation of low current devices being developed, a hat containing ion harvesting material may provide enough charge, or supplemental charge, collected over time to help power low current devices such as future cell phones, tracking devices, GPS, audio devices, smart glasses, etc. Clothes may also be included as examples of support structures. Friction of the ion collection material (such as non-limiting examples of carbon, graphite, silicene and graphene) against unlike materials, such as wool, polyester, cotton, etc. (used in clothes) may cause a voltage to be generated when rubbed together. Additionally, wind passing over the ion collection material has been demonstrated to generate voltage, even at low altitude. In an additional example embodiment, embedding collection devices into automobile tires (for example, in a particular pattern) could generate collectible voltage.

FIG. 16 provides an example embodiment of the ion collectors used in electro-hydrodynamic (EH) system 1600 of energy collection. In an EH system, wind energy is used to produce electrical energy. In an example system, upstream collector 1610 and downstream collector 1620 are used to create an electric field between them. Injector 1630 is then used to inject particles into the electric field to carry the electrical charge between the upstream and downstream collectors 1610, 1620. Injector 1630 may inject a fine mist between collectors 1610, 1620. The injection source may be naturally created or man-made. Depending on the conditions, either of upstream and downstream collectors 1610, 1620 may be optional. Injector 1630 may be used to generate the electric field, and as upstream and/or downstream collector 1610, 1620. In an example embodiment, collectors 1610, 1620 comprise a material, as provided above, that includes, in operation, microscopic points of a cross section of the collection device exposed to the environment, such as with carbon, graphite, silicene, and graphene. Collectors 1610, 1620 may be formed in many arrangements, as provided above, such as free strands or in a mesh arrangement, among others. EH system 1600 may be attached to any support structure, such as airplane, rocket, drone, aerostat, blimp, balloon, kite, satellite, train, motorcycle, bike, skateboard, scooter, hovercraft, electronic device, electronic device case, billboard, cell tower, radio tower, camera tower, flag pole, telescopic pole, light pole, utility pole, water tower, building, sky scraper, coliseum, roof top, solar panel and a fixed or mobile structure exceeding 1 inch in height above ground or sea level.

FIG. 17 provides an example embodiment of a system of utilizing radioactive or other ionizing radiation sources in collecting energy. The utilization of radioactive or other ionizing radiation sources may provide benefits, including a) increasing the level of energy produced by ion harvesting methods, b) increasing the electrical conductivity of the localized atmosphere around or near ion harvesting systems, c) decreasing the electrical resistivity of the localized atmosphere around or near ion harvesting systems, and d) increasing the ionization of the local atmosphere around or near ion harvesting systems. In example embodiments, the radioactive or ionizing source may be exposed openly to the atmosphere, enclosed in a sealed container, or contained in a partially sealed container.

Examples of radioactive or ionizing radiation sources include carbon-14, uranium, thorium, tritium, americium-241, radium, radon, cobalt-60, cesium-137, potassium-40, lead-210, iodine-131, technetium, and iridium-192 among others.

In an example embodiment, panel 1710 of collectors 1720 are attached to support platform 1700, such as an aerostat. An electrical source may be connected to collectors 1720 (including carbon, carbon-14, or metal, for example) in a manner that the electric current discharges from collectors 1720 to the atmosphere, or from the atmosphere to collector 1720, in that the atmosphere's electric current discharges to the carbon fiber (or other electrical conductor including metal).

In an example embodiment, capsules 1730 are attached directly to aerostat 1700 by methods including, but not limited to hook and loop, adhesive, sewing, and/or pouches attached to anchor points on support structure 1700 or by any mechanical means to support structure 1700. In an example embodiment, magnetic means are implemented to attach the radioactive material 1730 to the collection devices 1720 or support structure 1700.

In an example embodiment, radioactive capsules 1730 are attached to the collection material 1720. In an example implementation, the collection material 1720 is threaded through a passageway in capsule 1730 and attached by methods including, but not limited to hook and loop, adhesive, sewing, and/or pouches attached to anchor points on support structure 1700 or by any mechanical means to support structure 1700. Capsules 1730 may be attached to points of structured panel 1710 of collectors 1720. Capsules 1730 may be attached to loops in collectors 1720. Collectors 1720 may be tied in knots or other cable structures/configurations around capsules 1730.

In the example embodiment of FIG. 18, panel 1810 of collectors 1820 are attached to support platform 1800, such as an aerostat. Radioactive material 1830 may be incorporated into a paste, viscous liquid/material, or other spreadable substrate and applied to support platform 1800, collectors 1820, and/or structured support 1800 for one or more collectors 1820. Radioactive material 1830 may have magnetic properties and may be applied to platform 1800, collectors 1820, panel 1810, or other points using the magnetic properties.

In an example embodiment, radioactive material/powder is combined with a magnetic material such as ferrofluid, as a non-limiting example, to apply to panel 1810, collectors 1820, support structure 1800, and other points. In the manufacturing process of collectors 1820, the radioactive material may be embedded in the collector material, such as a resin as a non-limiting example.

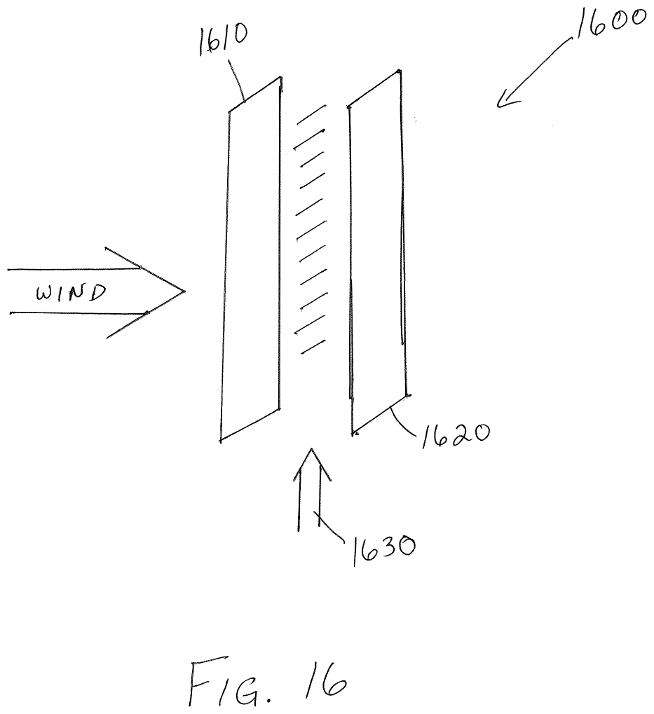

In the example embodiment of FIG. 19, collection devices 1920 are structured into panel type configuration 1910. Panel 1910 may be attached to support structure 1900 such as an aerostat, as a non-limiting example. Panel 1910 may be attached to support structure 1900 and may be spaced a distance from support structure 1900 for safety reasons, for example. Theoretically, the larger the surface area of panel 1910 of collection devices 1920 that is exposed to the atmosphere, the more energy may be collected by collection devices 1920. If panel 1910 is attached directly to support structure 1900, there may be airflow on only one side of the panel and that side is the only side that is exposed for collection of ions. However, if panel 1910 is separated from support structure 1900 by an appropriate amount, such that airflow is achieved on both sides of panel 1910, twice the surface area is accessible to the airflow and to the ions to be collected by collection devices 1920. In an example embodiment, panel 1910 of collection devices 1920 is separated from support structure 1900 with pillars 1930. The amount of distance between the collection devices 1920 and support structure 1900 may be increased by utilizing larger anchors points or pillars or spacers, or cables, etc. to secure the collection devices 1920 to support structure 1900. The anchor points, pillars, spacers, or cables 1930 may range in size from zero inches (ie: flush against the aerial platform) up to 500 ft. or greater arranged in a manner that the distance between collection devices 1920 and support structure 1900 is from 0 inches up to 500 ft. or greater.

In an example embodiment, the collection device comprises more than one fiber and may be arranged as braided fibers. The braided fibers may be collected together with an adherent such as epoxy. The adherent may obstruct ions from being attracted to the collection points on the fiber, and, so, minimizing the adherent may lead to increasing the energy collection efficiency.

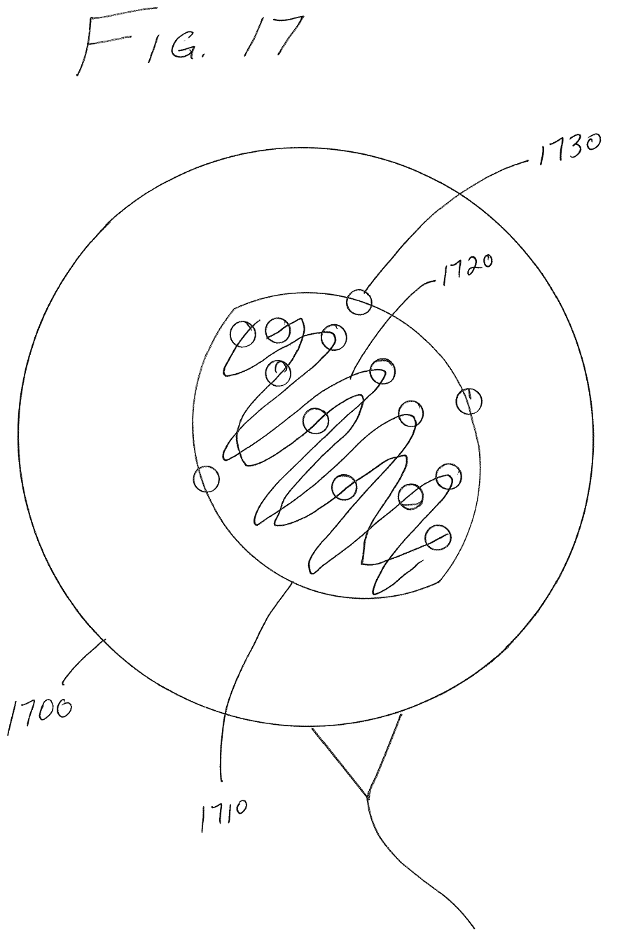

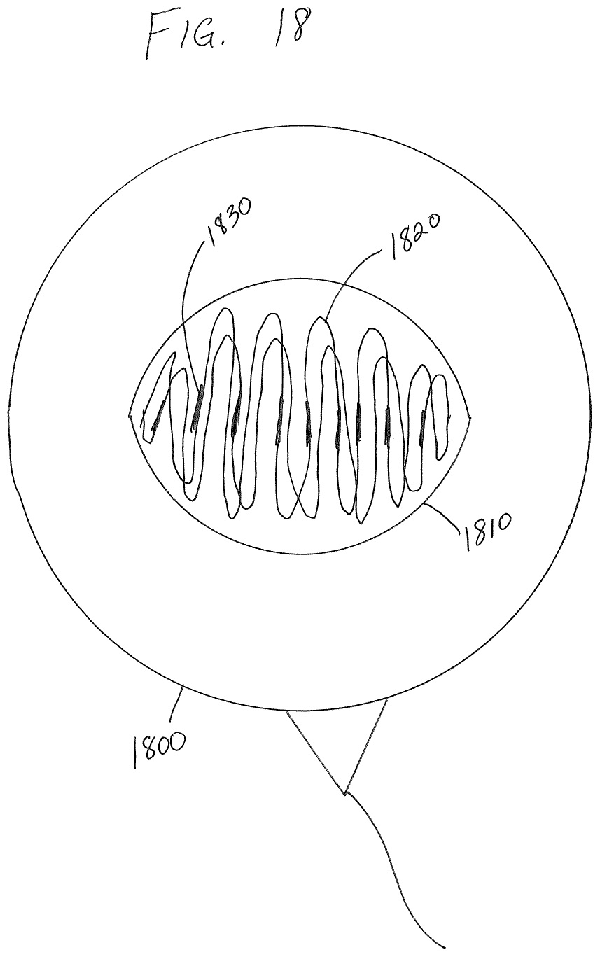

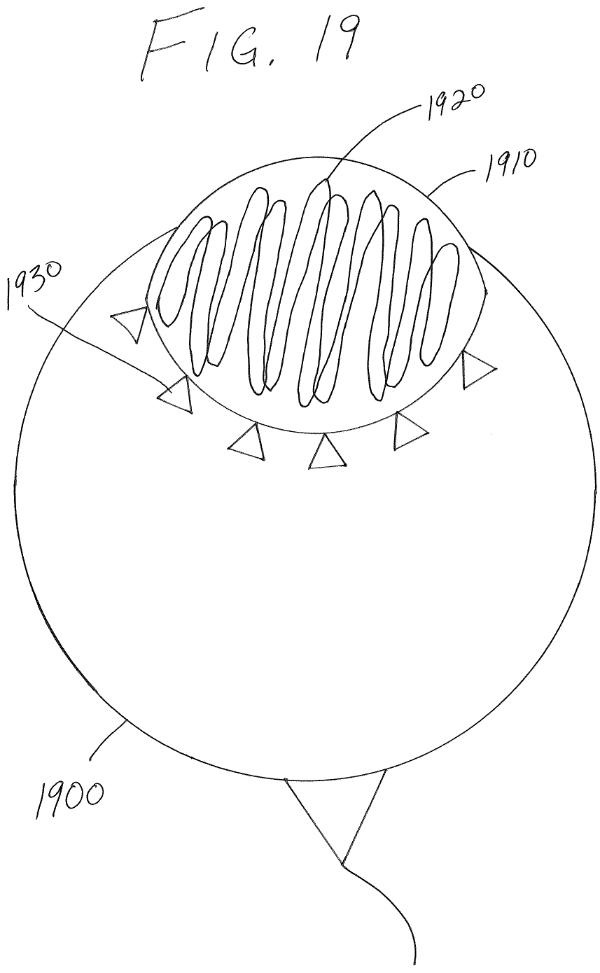

In an example embodiment, fluffing or fraying the collection fibers may increase the efficiency of the collection device. FIG. 20A provides a view of an example embodiment of collection device 2000 that is unfrayed. Collection device 2000 provides ion collector functionality through the microscopic points of the collection device. By fluffing or fraying collection device 2000, the exposure of, or the number of collection points is increased and the magnitude of energy collection is increased. FIG. 20B provides a view of collection device 2010 that has been frayed on one end in a uni-fluffed configuration. Collection device 2010 is frayed starting at position 2014 between two ends 2012 and 2016 of collection device 2010. At end 2012, collection device 2010 is unfrayed and at end 2016, collection device 2010 is frayed. In an example embodiment, collection device 2010 comprises a collection panel. The panel may be fluffed on one portion/end/side with another portion/end/side unfluffed in a uni-fluffed configuration.

FIG. 20C provides a view of an example embodiment of collection device 2020 that is bi-fluffed, or fluffed on both ends 2024, 2026 with unfrayed section 2022 in between fluffed ends 2024 and 2026. In an alternative example embodiment, collection device 2020 comprises multiple fluffed sections and multiple unfluffed sections producing a multi-fluffed configuration. This bi-fluffed configuration may be called a mustache fluffed or mustache (d) configuration. In example embodiments, unfrayed section 2022 is at the midpoint of collection device 2020. In an alternative embodiment, unfrayed section 2022 is at a point away from the midpoint of collection device 2020.

FIG. 20D provides a view of an example embodiment of collection device 2030 in an omni-fluffed configuration. Both ends 2034 and 2036 are fluffed, as is midsection 2032 between ends 2034 and 2036. In an example embodiment, the entirety of collection device 2030 is fluffed. In an alternative embodiment multiple configurations are used along collection device 2030. One or more configurations/combinations of unfluffed, uni-fluffed, bi-fluffed, and omni-fluffed may be implemented.

Collection device 2030 may be fluffed with many processes or methods, including mechanical fluffing. Mechanical fluffing may be achieved, as a non-limiting example, with a wire brush or other abrasive device; compressed air/gases; spraying it with sand or particulates, including water or liquids; exposing it to natural wind currents; and pulsed or steady, focused or unfocused, acoustics.

FIG. 21 provides a perspective view of an example embodiment of collection devices in wheel and spoke configuration 2100. Wheel and spoke configuration 2100 comprises outer ring 2104 and center 2106 between which collection devices 2102 are electrically connected. In an example embodiment, one or both of outer ring 2104 and center 2106 are conductive materials, such as copper as a non-limiting example. In an example embodiment, one or more collection devices 2102 are fluffed according to one or more of the configurations provided in FIGS. 20A, 20B, 20C, and 20D. Outer ring 2104 provides support and/or structure for collection devices 2102 such that collection devices 2102 form a substantially circular shape. Although a circular shape may be used, other two-dimensional shapes may also be used. These shapes include but are not limited to semicircle, ellipse, oval, triangle, square, rectangle parallelogram, rhombus, trapezoid, kite, pentagon hexagon, heptagon, octagon, nonagon, decagon, and a combination of one or more shapes, among others.

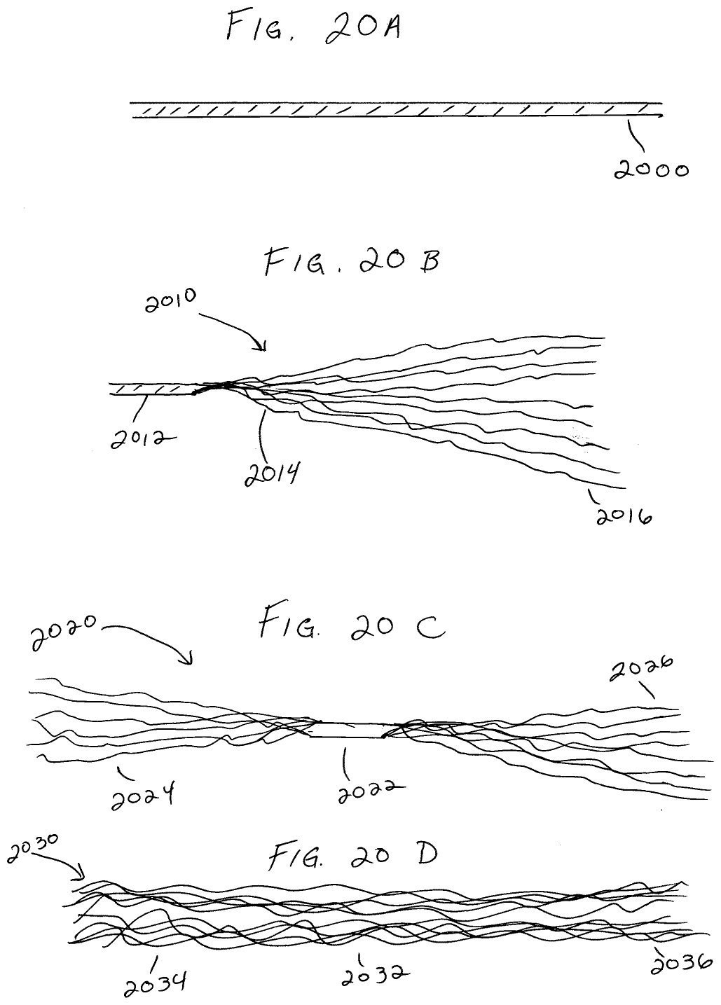

FIG. 22 provides a perspective view of an example embodiment of collection devices in a spherical configuration. Spherical configuration 2200 comprises outer shell 2204 and pole 2206 between which collection devices 2202 are electrically connected. In an example embodiment, one or both of outer shell 2204 and center 2206 are conductive materials, such as copper as a non-limiting example. In an example embodiment, one or more collection devices 2202 are fluffed according to one or more of the configurations provided in FIGS. 20A, 20B, 20C, and 20D. Shell 2204 provides support and/or structure for collection devices 2202 such that collection devices 2202 form a substantially spherical shape. Although a spherical shape may be used, other three-dimensional shapes may also be used. These shapes include but are not limited to balloon, cylinder, cone, cube, cuboid, prism, ring torus (donut), horn torus, spindle torus, tetrahedron, dodecahedron, icosahedron, pentagonal prism, helix, conic spiral, and a combination or one or more of the shapes, among others. Collection devices 2202 may be employed on or substantially form the surface of the three-dimensional shape. In an alternative embodiment, one or more collection devices 2202 may pass through the inside of shell 2204.

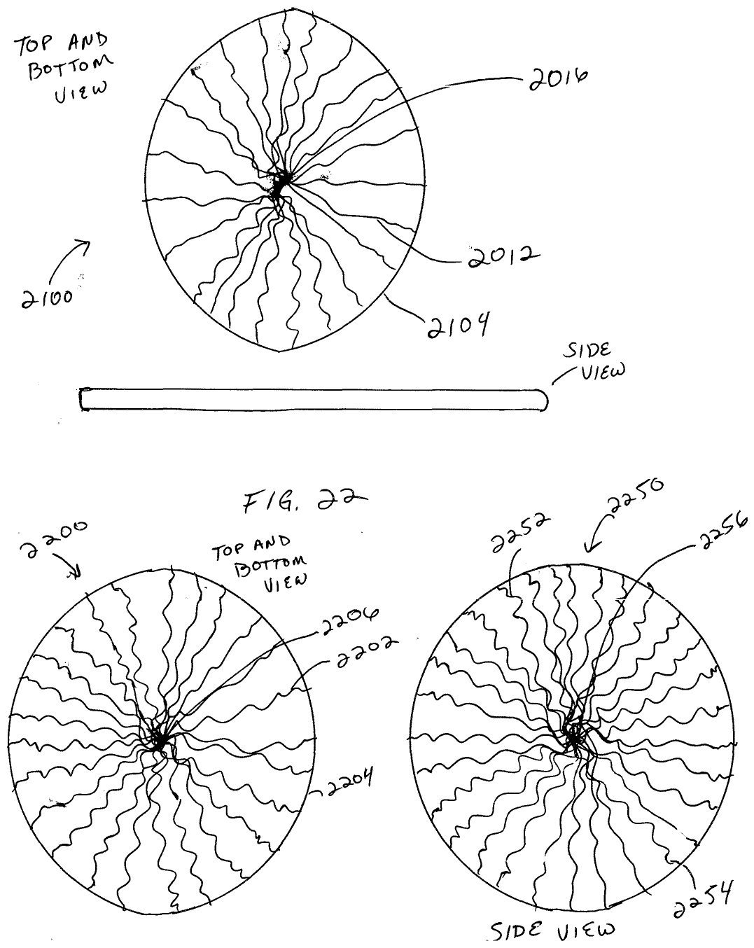

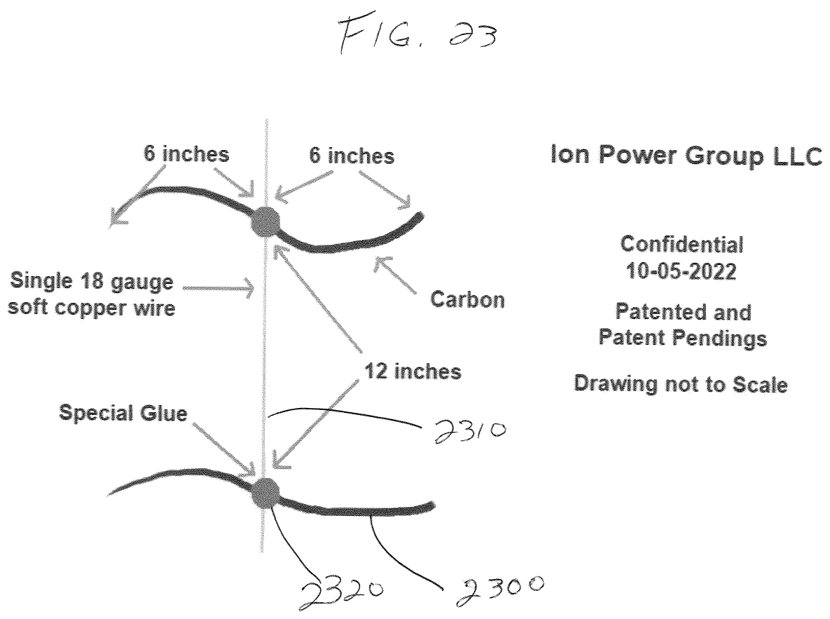

FIG. 23 provides a system diagram of an example embodiment of collection devices in a mustache configuration. One or more collection devices 2300 are electrically connected to support conductor 2310 and connection points 2320. In an example embodiment, support conductor 2310 is 18-gauge copper wire, collection devices 2300 are constructed in mustache configuration 2020 of FIG. 20C, each side of mustached configuration 2020 is 6 inches long on either side of connection points 2320, and connection points 2320 are 12 inches apart. Although this is an example embodiment, other dimensions may be employed. To prevent entanglement of collection devices 2300, the distance between connection points 2320 may be twice in magnitude as the longest length of collection device 2300 from connection point 2320. In example embodiments, collection devices 2300 are connected to connection points 2320 at the middle of collection devices 2300. In an alternative embodiment, collection devices 2300 are connected to connection points 2320 at a point away from the middle of collection devices 2300.

FIG. 24 provides a system diagram of an example embodiment of collection devices in a net configuration. Mesh or net 2480 provides the support and/or structure for collection devices 2400 attached to support conductor 2410 at connection points 2420. In an example embodiment, support conductor is configured in a snake or serpentine configuration back and forth across net 2480. In an alternative embodiment, support conductor 2410 is configured in non-limiting examples of at least one of a spiral shape, ellipse, straight line, curved line, and repeating pattern. One or more collection devices 2400 are electrically connected to support conductor 2410 and connection points 2420. In an example embodiment, support conductor 2410 is 18-gauge copper wire, collection devices 2400 are constructed in mustache configuration 2020 of FIG. 20C, each side of mustached configuration 2020 is 6 inches long on either side of connection points 2420, and connection points 2420 are 12 inches apart. Although this is an example embodiment, other dimensions may be employed.

To prevent entanglement of collection devices 2400, the distance between connection points 2420 may be twice in magnitude as the longest length of collection device 2400 from connection point 2420. The applies to the distance between connection points 2420 along support conductor 2410 as well as the distance between adjacent legs of the snake, spiral, or other shapes. In example embodiments, collection devices 2400 are connected to connection points 2420 at the middle of collection device 2400. In an alternative embodiment, collection devices 2400 are connected to connection points 2420 at a point away from the middle of collectors 2400.

Collection devices 2400 may be connected at connection points 2420 by one or more connection methods, including, as non-limiting embodiments, electrically conductive or non-conductive adhesive, and mechanical attachment means such as knots, zip tie, hook and loop, or the like. In an example embodiment, collection devices 2400 are sprayed onto a support structure, including, for example, a conductive wire, an aerostat, and a conductive tether, among others. In an example embodiment, collection devices 2400 may be rolled on to a support structure. In an example embodiment, collection devices 2400 are maintained in position on a support structure by gravity.

Although, the example embodiments disclosed herein may be used in terrestrial applications, they may also be used in extra-terrestrial applications, on the moon and other planetary bodies. For example, Earth's moon holds an electric charge due to a continuous influx of electrons and protons from the solar wind and cosmic rays. This natural electric charge primarily resides within the Earth's moon's dust particles and surface, known as regolith, especially at ground level and at lower altitudes, and it's estimated to be in the kilovolt range.

The surface of Earth's moon is known to be negatively charged from the constant bombardment of electrons and protons from the solar wind. The resulting negative electrostatic charge on the dust particles, in the lunar vacuum, causes them to repel each other minimizing the potential. The result is a layer of suspended dust about one meter above the lunar surface. This phenomenon was observed by both Clementine and Surveyor spacecrafts. In the lunar vacuum, the charge on the particles can be extremely high, charged with up to several thousand volts.

FIG. 25 provides an example embodiment of collection devices configured relative to the surface of a planetary body, such as Earth's moon. At least two electrodes (one or both of which may be a collection device) 2510, 2520 are electrically connected to power processing 2500 either in series or in parallel. In the example embodiment of FIG. 25, at least one electrode 2510 is positioned above surface 2530 and at least one electrode 2520 is positioned below surface 2530. In an example embodiment, power processing 2500 receives energy from the at least two electrodes 2510, 2520. A load may be part of power processing 2500 or external to power processing 2500. Alternatively, power processing 2500 may be directly connected to a power grid. In an example embodiment, power processing 2500 conditions the electric energy signal. The conditioning may be in the time domain (by voltage or current (DC or AC)) or in the frequency domain. A non-limiting example of power processing 2500 is a DC-AC inverter. In an example embodiment, power processing 2500 comprises one or more storage devices, such as non-limiting examples of a capacitor, battery, and hydrogen fuel cell.

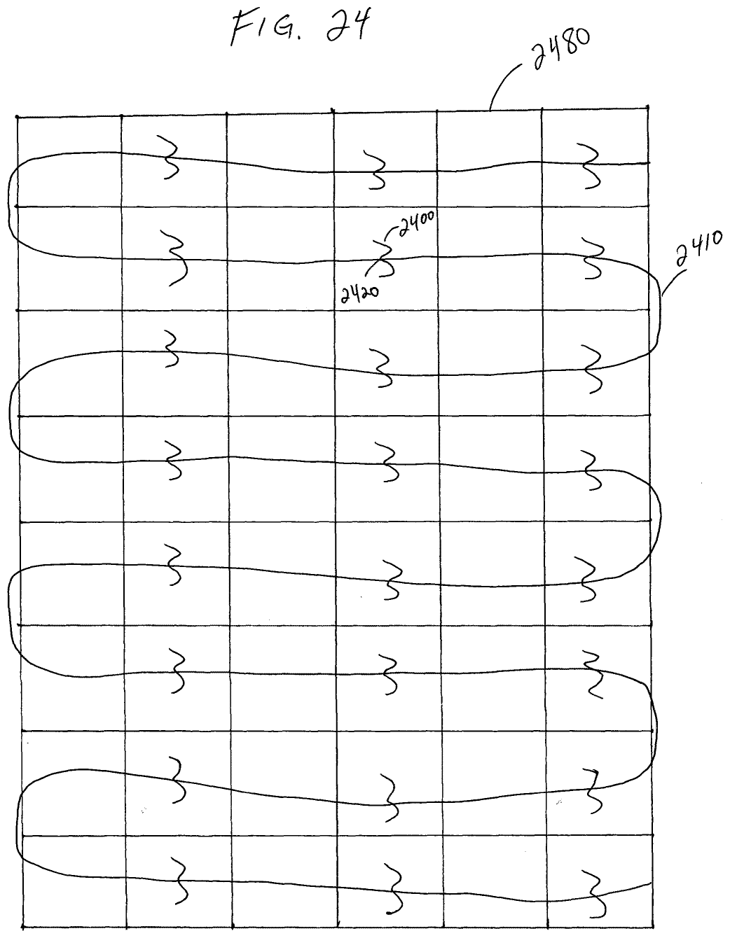

FIG. 26 provides an example embodiment of collection devices configured relative to the surface of a planetary body, such as Earth's moon. At least two electrodes (one or both of which may be a collection device) 2610, 2620 are electrically connected to power processing 2600. In the example embodiment of FIG. 26, at least one electrode 2610 is positioned at or on surface 2630 and at least one electrode 2620 is positioned below surface 2630. In an example embodiment, power processing 2600 receives energy from the at least two electrodes 2610, 2620. A load may be part of power processing 2600 or external to power processing 2600. Alternatively, power processing 2600 may be directly connected to a power grid. In an example embodiment, power processing 2600 conditions the electric energy signal. The conditioning may be in the time domain (by voltage or current (DC or AC)) or in the frequency domain. A non-limiting example of power processing 2600 is a DC-AC inverter. In an example embodiment, power processing 2600 comprises one or more storage devices, such as non-limiting examples of a capacitor, battery, and hydrogen fuel cell.

FIG. 27 provides an example embodiment of collection devices configured relative to the surface of a planetary body, such as Earth's moon. At least two electrodes (one or both of which may be a collection device) 2710, 2720 are electrically connected to power processing 2700. In the example embodiment of FIG. 27, at least one electrode 2710 is positioned below surface 2730 and at least one electrode 2720 is positioned below surface 2730. In an example embodiment, power processing 2700 receives energy from the at least two electrodes 2710, 2720. A load may be part of power processing 2700 or external to power processing 2700. Alternatively, power processing 2700 may be directly connected to a power grid. In an example embodiment, power processing 2700 conditions the electric energy signal. The conditioning may be in the time domain (by voltage or current (DC or AC)) or in the frequency domain. A non-limiting example of power processing 2700 is a DC-AC inverter. In an example embodiment, power processing 2700 comprises one or more storage devices, such as non-limiting examples of a capacitor, battery, and hydrogen fuel cell.

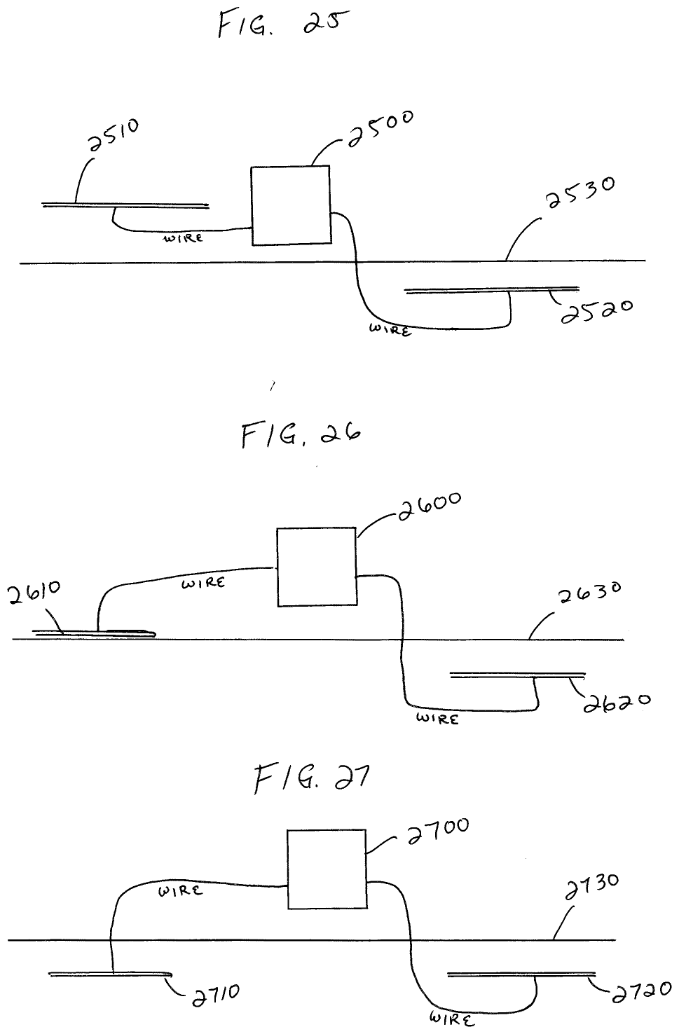

FIG. 28 provides an example embodiment of collection devices configured relative to the surface of a planetary body, such as Earth's moon. At least two electrodes (one or both of which may be a collection device) 2810, 2820 are electrically connected to power processing 2800. In the example embodiment of FIG. 28, at least one electrode 2810 is positioned above surface 2830 and at least one electrode 2820 is positioned above surface 2830. In this example embodiment, at least one electrode 2820 is positioned perpendicular to surface 2830. In an example embodiment, power processing 2800 receives energy from the at least two electrodes 2810, 2820. A load may be part of power processing 2800 or external to power processing 2800. Alternatively, power processing 2800 may be directly connected to a power grid. In an example embodiment, power processing 2800 conditions the electric energy signal. The conditioning may be in the time domain (by voltage or current (DC or AC)) or in the frequency domain. A non-limiting example of power processing 2800 is a DC-AC inverter. In an example embodiment, power processing 2800 comprises one or more storage devices, such as non-limiting examples of a capacitor, battery, and hydrogen fuel cell.

FIG. 29 provides an example embodiment of collection devices configured relative to the surface of a planetary body, such as Earth's moon. At least two electrodes (one or both of which may be a collection device) 2910, 2920 are electrically connected to power processing 2900. In the example embodiment of FIG. 29, at least one electrode 2910 is positioned above surface 2930 and at least one electrode 2920 is positioned at or on surface 2930. In an example embodiment, power processing 2900 receives energy from the at least two electrodes 2910, 2920. A load may be part of power processing 2900 or external to power processing 2900. Alternatively, power processing 2900 may be directly connected to a power grid. In an example embodiment, power processing 2900 conditions the electric energy signal. The conditioning may be in the time domain (by voltage or current (DC or AC)) or in the frequency domain. A non-limiting example of power processing 2900 is a DC-AC inverter. In an example embodiment, power processing 2900 comprises one or more storage devices, such as non-limiting examples of a capacitor, battery, and hydrogen fuel cell.

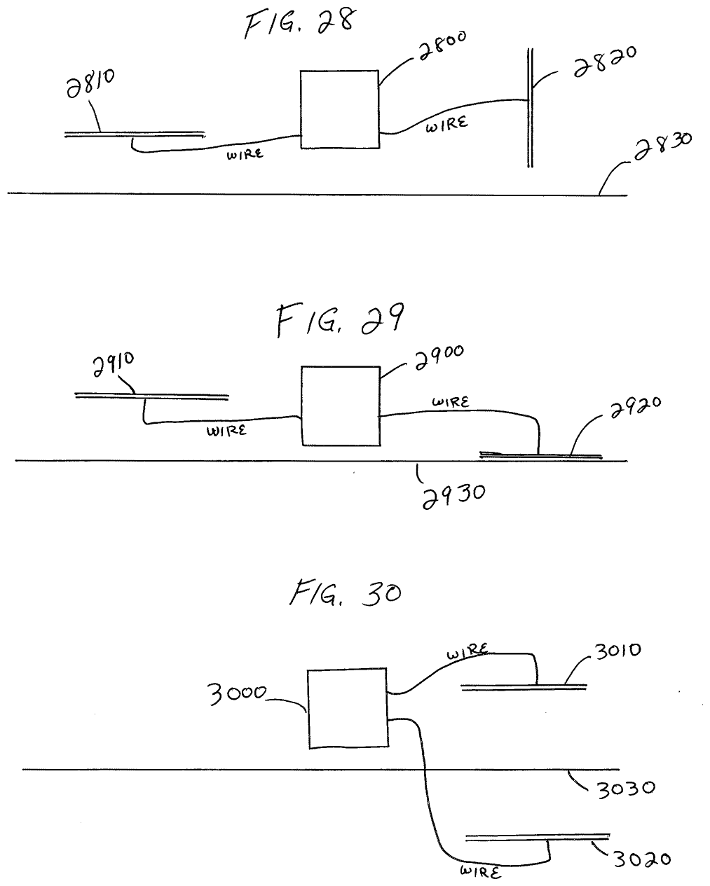

FIG. 30 provides an example embodiment of collection devices configured relative to the surface of a planetary body, such as Earth's moon. At least two electrodes (one or both of which may be a collection device) 3010, 3020 are electrically connected to power processing 3000. In the example embodiment of FIG. 25, at least one electrode 3010 is positioned above surface 3030 and at least one electrode 3020 is positioned below surface 3030. In this example embodiment, at least one electrode 3010 is positioned above at least one electrode 3020. In an example embodiment, power processing 3000 receives energy from the at least two electrodes 3010, 3020. A load may be part of power processing 3000 or external to power processing 3000. Alternatively, power processing 3000 may be directly connected to a power grid. In an example embodiment, power processing 3000 conditions the electric energy signal. The conditioning may be in the time domain (by voltage or current (DC or AC)) or in the frequency domain. A non-limiting example of power processing 3000 is a DC-AC inverter. In an example embodiment, power processing 3000 comprises one or more storage devices, such as non-limiting examples of a capacitor, battery, and hydrogen fuel cell.

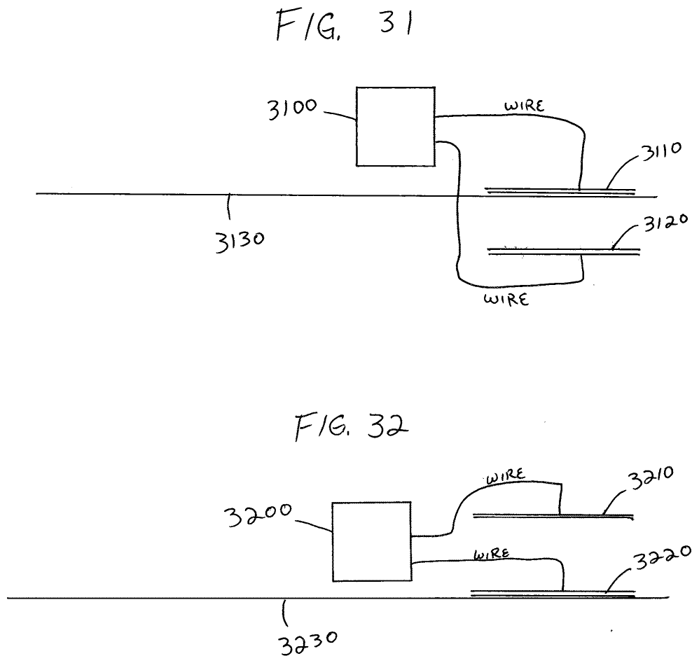

FIG. 31 provides an example embodiment of collection devices configured relative to the surface of a planetary body, such as Earth's moon. At least two electrodes (one or both of which may be a collection device) 3110, 3120 are electrically connected to power processing 3100. In the example embodiment of FIG. 31, at least one electrode 3110 is positioned at or on surface 3130 and at least one electrode 3120 is positioned below surface 3130. In this example embodiment, at least one electrode 3110 is positioned above at least one electrode 3120. In an example embodiment, power processing 3100 receives energy from the at least two electrodes 3110, 3120. A load may be part of power processing 3100 or external to power processing 3100. Alternatively, power processing 3100 may be directly connected to a power grid. In an example embodiment, power processing 3100 conditions the electric energy signal. The conditioning may be in the time domain (by voltage or current (DC or AC)) or in the frequency domain. A non-limiting example of power processing 3100 is a DC-AC inverter. In an example embodiment, power processing 3100 comprises one or more storage devices, such as non-limiting examples of a capacitor, battery, and hydrogen fuel cell.

FIG. 32 provides an example embodiment of collection devices configured relative to the surface of a planetary body, such as Earth's moon. At least two electrodes (one or both of which may be a collection device) 3210, 3220 are electrically connected to power processing 3200. In the example embodiment of FIG. 32, at least one electrode 3210 is positioned above surface 3230 and at least one electrode 3220 is positioned at or on surface 3230. In this example embodiment, at least one electrode 3210 is positioned above at least one electrode 3220. In an example embodiment, power processing 3200 receives energy from the at least two electrodes 3210, 3220. A load may be part of power processing 3200 or external to power processing 3200. Alternatively, power processing 3200 may be directly connected to a power grid. In an example embodiment, power processing 3200 conditions the electric energy signal. The conditioning may be in the time domain (by voltage or current (DC or AC)) or in the frequency domain. A non-limiting example of power processing 3200 is a DC-AC inverter. In an example embodiment, power processing 3200 comprises one or more storage devices, such as non-limiting examples of a capacitor, battery, and hydrogen fuel cell.

Although the example embodiments of FIGS. 25-32 are described in terms of the surface of the moon, the teachings are also applicable to other bodies such as, but not limited to, Mercury, Venus, Earth, Mars, Jupiter, Saturn, Neptune, Uranus, Titan, Triton, and Pluto, also including all moons, planetoids, asteroids, meteors, meteorites, comets, or other bodies located in space, natural or man-made, with or without an atmosphere.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A system of energy collection comprising:
a plurality of electrodes configured to be placed relative to a surface of a planetary body, and
a power processing module configured to collect energy conducted between at least two of the plurality of electrodes.

2. The system of claim 1, further comprising a load with an electrical connection to at least one of the plurality of electrodes, the load configured to draw current.

3. The system of claim 1, wherein at least one of the electrodes comprises a collection device with microscopic points of a cross-section of the collection device exposed to the environment.

4. The system of claim 1, wherein at least one of the plurality of electrodes is configured to be positioned above the surface of the planetary body and at least one of the plurality of electrodes is configured to be positioned below the surface of the planetary body.

5. The system of claim 4, wherein the at least one of the plurality of electrodes positioned above the surface of the planetary body is configured to be positioned over the at least one of the plurality of electrodes configured to be positioned below the surface of the planetary body.

6. The system of claim 1, wherein at least one of the plurality of electrodes is configured to be positioned substantially on the surface of the planetary body and at least one of the plurality of electrodes is configured to be positioned below the surface of the planetary body.

7. The system of claim 1, wherein at least two of the plurality of electrodes are configured to be positioned below the surface of the planetary body.

8. The system of claim 1, wherein at least two of the plurality of electrodes are configured to be positioned above the surface of the planetary body.

9. The system of claim 1, wherein at least one of the plurality of electrodes is configured to be positioned substantially on the surface of the planetary body and at least one of the plurality of electrodes is configured to be positioned above the surface of the planetary body.

10. The system of claim 1, wherein the power processing module comprises a load.

11. The system of claim 1, wherein the power processing module is configured to condition the collected energy.

12. The system of claim 11, wherein the energy is conditioned in the time domain.

13. The system of claim 11, wherein the energy is conditioned in the frequency domain.

14. The system of claim 1, wherein the power processing module comprises a storage device.

15. A method of collecting energy comprising:
positioning a plurality of electrodes relative to a surface of a planetary body;
collecting energy conducted between at least two of the plurality of electrodes; and
processing the energy collected between the at least two of the plurality of electrodes.

16. The method of claim 15, wherein at least one of the plurality of electrodes is configured to be positioned above the surface of the planetary body and at least one of the plurality of electrodes is configured to be positioned below the surface of the planetary body.

17. The method of claim 16, wherein the at least one of the plurality of electrodes positioned above the surface of the planetary body is configured to be positioned over the at least one of the plurality of electrodes configured to be positioned below the surface of the planetary body.

18. The method of claim 15, wherein at least one of the plurality of electrodes is configured to be positioned substantially on the surface of the planetary body and at least one of the plurality of electrodes is configured to be positioned below the surface of the planetary body.

19. The method of claim 15, wherein at least two of the plurality of electrodes are configured to be positioned below the surface of the planetary body.

20. The method of claim 15, wherein at least two of the plurality of electrodes are configured to be positioned above the surface of the planetary body.

21. The method of claim 15, wherein at least one of the plurality of electrodes is configured to be positioned substantially on the surface of the planetary body and at least one of the plurality of electrodes is configured to be positioned above the surface of the planetary body.
